(19) United States
(12) Patent Application Publication
(10) Pub. No.: US 2011/0262339 A1
(43) Pub. Date: Oct. 27, 2011

(54) PRODUCTION OF SOLAR-GRADE SILICON FROM SILICON DIOXIDE

(76) Inventors: Hartwig Rauleder, Rheinfelden (DE); Ekkehard Müh, Rheinfelden (DE); Mustafa Siray, Bonn (DE); Peter Nagler, Frankfurt (DE); Bodo Frings, Shloss Holte (DE); Ingrid Lunt-Rieg, Bad Homburg (DE); Alfons Karl, Grundau (DE); Christian Panz, Wesseling-Berzdorf (DE); Thomas Groth, Frankfurt (DE); Guido Stochniol, Haltern am See (DE); Matthias Rochnia, Ortenberg-Bleichenbach (DE); Jürgen Erwin Lang, Karlsruhe (DE); Oliver Wolf, Florstadt (DE); Rudolf Schmitz, Bornheim (DE); Bernd Nowitzki, Marl (DE); Dietmar Wewers, Bottrop (DE)

(21) Appl. No.: 13/121,759

(22) PCT Filed: Sep. 28, 2009
(86) PCT No.: PCT/EP09/62515

§ 371 Date: Jul. 13, 2011

Related U.S. Application Data
(60) Provisional application No. 61/110,828, filed on Nov. 3, 2008.

(30) Foreign Application Priority Data
Sep. 30, 2008 (DE) 10 2008 042 506.0

(51) Int. Cl. C01B 33/025

(52) U.S. Cl. 423/350

(57) ABSTRACT

The invention relates to a complete method for producing pure silicon that is suitable for use as solar-grade silicon, comprising the reduction of a purified silicon oxide using one or more pure carbon sources, the purified silicon oxide, which was purified as silicon oxide dissolved in an aqueous phase, having a content of other polyvalent metals or metal oxides, in relation to the silicon oxide, of less than or equal to 300 ppm, preferably less than 100 ppm, especially preferably less than 50 ppm and according to the invention less than 10 ppm of the other metals and being obtained advantageously by gel formation in alkaline conditions. The invention also relates to a formulation containing an activator and to the use of purified silicon oxide together with an activator for producing silicon.

The invention relates to a complete method for the production of pure silicon, which is suitable as solar-grade silicon, comprising the reduction of a silicon oxide, purified by acid precipitation from aqueous solution of a silicon oxide dissolved in aqueous phase, with one or more sources of pure carbon, in particular the purified silicon oxide is obtained by precipitation of a silicon oxide dissolved in aqueous phase in an acidifying agent. The invention further relates to a formulation containing an activator, and a device for the production of silicon, a reactor and electrodes.

The proportion of photovoltaic cells in global electricity generation has been increasing steadily for some years. For further increase of market share, it is essential for the production costs of photovoltaic cells to be lowered and for their efficiency to be increased.

The costs for high-purity silicon (solar-grade silicon) are an important cost factor in the production of photovoltaic cells. On an industrial scale this is usually produced by the Siemens process, which was developed more than 50 years ago. In this process silicon is first reacted with gaseous hydrogen chloride at 300-350° C. in a fluidized-bed reactor to trichlorosilanes (silicochloroform). After costly distillation steps, in a reversal of the above reaction, the trichlorosilanes are thermally decomposed again at 1000-1200° C. in the presence of hydrogen on heated rods of very-high-purity silicon. The elemental silicon grows on the rods and the hydrogen chloride released is recycled. Silicon tetrachloride is produced as a by-product; this is either converted to trichlorosilanes and recycled to the process or it is burnt in an oxygen flame to pyrogenic silicic acid. A chlorine-free alternative to the above process is the decomposition of monosilanes, which can also be obtained from the elements and decomposes again after a purification step on heated surfaces or on being passed through fluidized-bed reactors. Examples of this are given in WO 2005/118474 A1.

Another known method for the production of silicon is reduction of silicon dioxide in the presence of carbon in accordance with the following reaction equation (Ullmann's Encyclopedia of Industrial Chemistry, Vol. A 23, pages 721-748, 5th edition, 1993 VCH Weinheim).

SiO₂+2C→Si+2CO

For this reaction to occur, very high temperatures, preferably above 1700° C., are required, which can be attained for example in arc furnaces. Despite the high temperatures, this reaction starts very slowly, and then also proceeds at a low rate. Owing to the associated long reaction times, this method is both energy-intensive and cost-intensive.

If the silicon is to be used in solar applications, the silicon produced must fulfil particularly high requirements on purity. Even contamination of the starting compounds in the mg/kg (ppm range), (μg/kg) ppb to ppt range are troublesome in this field of application.

Owing to their electronic properties, elements of groups III and V of the periodic system are especially troublesome, so that for these elements the limit values of contamination in silicon are particularly low. For pentavalent phosphorus and arsenic, for example, the resultant doping of the silicon produced as n-type semiconductor is problematic. Trivalent boron also leads to undesirable doping of the silicon produced, so that a p-type semiconductor is obtained. For example, there is a solar-grade silicon (Si_{sg}) with a purity of 99.999% (“five nines”) or 99.9999% (“six nines”). Silicon suitable for semiconductor manufacture (electronic grade silicon, Si_{eg}) requires even higher purity. For these reasons even metallurgical silicon from the reaction of silicon oxide with carbon should meet high purity requirements, in order to minimize subsequent costly purification steps due to entrained halogenated compounds, such as boron trichloride, in the halosilanes for the production of silicon (Si_{sg} or Si_{eg}). Contamination with boron-containing compounds causes particular difficulties, because boron has a distribution coefficient of 0.8 in molten silicon and in the solid phase and therefore can scarcely be separated any longer from silicon by zone melting (DE 2 546 957 A1).

In general, methods for the production of silicon from silicon oxide are known from the prior art. Thus, DE 29 45 141 C2 describes the reduction of porous glasses of SiO₂ in an arc. The carbon particles necessary for the reduction can be embedded in the porous glass. The silicon obtained by the disclosed method is suitable at a boron content of less than 1 ppm for the production of semiconductor components. DE 33 10 828 A1 adopts the approach of decomposition of halogenated silanes on solid aluminium. This certainly ensures a low boron content, but the aluminium content of the silicon obtained is higher and the energy consumption of the process is appreciable owing to the need for electrolytic recycling of the aluminium chloride that forms.

DE 30 13 319 discloses a method for the production of silicon of a specified purity, starting from silicon dioxide and a carbon-containing reducing agent, such as carbon black, stating the maximum boron and phosphorus contents. The carbon-containing reducing agent was used in the form of pellets with a high-purity binder, such as starch.

WO 2007/106860 A1 describes a method for the production of silicon, in which sodium silicate in aqueous phase is led over ion exchangers for separation of boron, to obtain boron-free purified sodium silicate in aqueous phase. Next, silicon dioxide is precipitated from the purified aqueous phase. This method has the disadvantage that primarily only boron and phosphorus impurities are eliminated from the sodium silicate. To obtain solar-grade silicon of sufficient purity it is in particular also necessary to remove metallic impurities. For this, WO 2007/106860A1 proposes the use of additional ion-exchange columns in the process. This leads, however, to a very expensive process with low space-time yield.

In order to produce silicon of a suitable grade for solar cell manufacture, generally it is necessary to use silicon dioxide with a purity of at least 99.99 wt. %. The concentration of impurities, such as boron and phosphorus, should not exceed 1 ppm. Admittedly it is possible to use natural resources, such as high-quality quartz, as silicon dioxide starting material of high purity, but owing to their natural limitation they are only available in limited amounts for industrial mass production. Moreover, from economic aspects their procurement is too expensive. What the methods described above have in common is that they are either very expensive and/or energy-intensive, so that there is a high demand for less expensive, more efficient methods for the production of solar-grade silicon.

Therefore there is a demand for the production of high-purity silicon dioxide from readily available, inexpensive silicates. Methods are known in which a fluxing agent is added to a silicon-containing material, such as silica sand or feldspar, and the mixture is melted. A fibre-like silicate glass is pulled from the melt and is lixiviated with an acid, with formation of pulverulent porous silicon dioxide (SiO₂) (DE 31 23 009). For the production of high-purity silicon dioxide by lixiviation, the glass mass is restricted to those that can be lixiviated easily, and aluminium oxide and alkaline-earth metal salts must also be added as glass ingredients to the silicon dioxide. A serious drawback is the need for subsequent removal of the metals with the exception of the silicon dioxide.

A method is also known in which a silica gel is obtained by reacting an alkali silicate (which is generally known as water glass or soluble silicate) with an acid (cf. for example J. G. Vail, “Soluble Silicates” (ACS Monograph Series), Reinhold, N.Y., 1952, Vol. 2, p. 549). This silica gel leads as a rule to an SiO₂ with a purity of about 99.5 wt. %, in any case the content of impurities, such as boron, phosphorus, iron and/or aluminium is too high for this silicon dioxide to be used for the production of solar-grade silicon. As silicate solutions are available in very large amounts as a very inexpensive raw material, in the past there has been no lack of attempts to produce high-purity SiO₂ from silicate solutions. Thus, U.S. Pat. No. 4,973,462 describes processes in which highly viscous water glass was converted at low pH value of the reaction solution with an acidifying agent to SiO₂. This SiO₂ was then filtered, washed with water, resuspended in a mixture of acid, water and a chelating agent, filtered and washed several times. A similar method was described in JP02-311310, but in this case a chelating agent was already added in the precipitation reaction. These two methods have the disadvantage that they include a very elaborate processing procedure. Moreover, it was found that the precipitates obtained are sometimes difficult to filter. Finally, there are additional costs for the chelating agent and its separation from the silicon dioxide.

The aim of the invention was to provide a complete method for the production of solar-grade silicon, which is economical on an industrial scale, with a reduced number of process stages, and can be carried out advantageously using ordinary, preferably not prepurified silicates or silicon dioxides as starting materials and production of purified silicon oxide. Another aim was to develop a reactor and electrodes, which on the one hand make economical processing possible, and on the other hand suppress the diffusion-dependent contamination with boron from plant components at high temperatures.

A further aim within the context of the complete method was to provide a new method for the production of high-purity silicon dioxide which has at least some disadvantages of the aforementioned prior art methods only in reduced form, if at all.

Further aims which are not mentioned specifically will become clear from the general context of the description in the examples and the claims which follow. These aims are achieved by the method described in the description, the examples and the claims, the method steps described therein and the products and intermediates described therein.

It was found, surprisingly, that an economical method of production of pure silicon, which is suitable as solar-grade silicon or is suitable for the production of solar-grade silicon, can be provided by reduction of a purified silicon dioxide with one or more sources of pure carbon, the purified silicon dioxide being obtained by precipitation in an acidifying agent, in particular by reacting at least one aqueous solution of a silicon oxide dissolved in aqueous phase with at least one acidifying agent in acidic conditions.

According to the invention, the precipitation takes place in an acidifying agent to which the silicon oxide, dissolved in aqueous phase, is added, and forms the resultant precipitation suspension. The precipitation suspension is kept acidic during the addition of and/or precipitation of the silicon oxide.

The aim is achieved by the complete method described in detail in the description, the examples, the figures and the claims which follow for the production of pure silicon and by the method components described therein.

The invention therefore relates to a method for the production of pure silicon, more particularly of solar-grade silicon or of a silicon suitable for the production of solar-grade silicon, comprising the reduction of silicon dioxide, purified by precipitation from aqueous solution, with one or more sources of pure carbon, wherein the precipitation takes place from an aqueous solution of a silicon dioxide dissolved in an aqueous phase in an acidifying agent, especially in the acidic pH range, and the resulting precipitation suspension is kept permanently at an acidic pH.

It has been found that silicon dioxides, more particularly the silicon dioxide purified by acidic precipitation, can be used not only as a raw material for reaction with the carbon source to give silicon, but that it can also be used in the production of the carbon source or of reaction accelerators or of reactor materials.

In addition, it has been found that carbohydrates are particularly suitable as the preferred second starting material, for example carbon source, in the context of the present invention. These carbohydrates may serve as the carbon source or as one of the carbon sources in different component steps of the method, but may also be used for production of activators or reactor materials. Carbohydrates have the particular advantage that they are available globally, have very low values with regard to impurities of boron and phosphorus, and, being a renewable raw material, constitute an ecologically viable carbon source.

The present invention therefore also relates to a method according to Claim 1, in which the carbon source carbon is obtained by pyrolysis of carbohydrates in a component step of the method, using SiO₂, especially a silicon dioxide purified by acidic precipitation, as an antifoaming agent in the pyrolysis.

The present invention further relates to a method according to Claim 1, in which high-purity silicon carbide is prepared from silicon dioxide and carbohydrates in a component step of the method, and this silicon carbide is preferably used for one or more of the following purposes:
a) for lining reactor components
b) for producing electrodes for the blast furnace process
c) as a carbon source for the reaction with the silicon dioxide purified by acidic precipitation
d) as a reaction accelerator for the reaction of another carbon source with the silicon dioxide purified by acidic precipitation.

Finally, the present invention relates to an especially preferred reactor for performance of the process according to the invention.

In a very specific method variant of the present invention, only silicon dioxide purified by aqueous means and sugar are used in the complete method.

The method according to the invention is described in detail below:

### DEFINITIONS

Precipitation or precipitation process means, in the sense of the present invention, the reaction of at least one aqueous solution of a silicon oxide dissolved in aqueous phase with at least one acidifying agent in the conditions defined more precisely in the rest of the description, regardless of whether the reaction leads to formation, from the primary particles, of aggregates and agglomerates—in the sense of the usual definition for precipitated silicic acids—or of a three-dimensional network—in the sense of the usual definition of silica gels. In other words, the high-purity SiO₂ particles according to the invention can assume a gel-like structure or a structure of a precipitated silicic acid or even some other structure.

“Silicon dioxide purified by precipitation from aqueous solution” means a silicon dioxide which is obtained by a method in which the reaction regime in the reaction of an acidifying agent and of a silicate and subsequent washing steps with acidifying agents and/or aqueous solutions of acidifying agents and/or water, preferably demineralised water, achieve a total content of aluminium, boron, calcium, iron, nickel, phosphorus, titanium and zinc in the silicon dioxide below 10 wt.-ppm, and the total of the impurities of aluminium, boron, calcium, iron, nickel, phosphorus, titanium and zinc in the silicon dioxide below the total of the impurities present in the educts and the water. In other words, the precipitation is conducted in such a way that the abovementioned impurities in the educts and in the washing media remain as far as possible in the aqueous phase and are not transferred to the silicon dioxide. In a specific embodiment of the present invention, “silicon dioxide purified by precipitation from aqueous solution” means that commercially available technical acidifying agent is reacted with commercially available technical silicate solution, and the reaction and the washing steps are conducted such that, in spite of the non-prepurified educts, a high-purity silicon dioxide is obtained.

“Pure or high-purity silicon” means silicon with a profile of impurities as given below:
a. Aluminium less than or equal to 5 ppm or between 5 ppm and 0.0001 ppt, in particular between 3 ppm and 0.0001 ppt, preferably between 0.8 ppm and 0.0001 ppt, especially preferably between 0.6 ppm and 0.0001 ppt, still better between 0.1 ppm and 0.0001 ppt, quite especially preferably between 0.01 ppm and 0.0001 ppt, and even more preferably 1 ppb to 0.0001 ppt,
b. Boron below 10 ppm to 0.0001 ppt, in particular in the range from 5 ppm to 0.0001 ppt, preferably in the range from 3 ppm to 0.0001 ppt or especially preferably in the range from 10 ppb to 0.0001 ppt, even more preferably in the range from 1 ppb to 0.0001 ppt
c. Calcium less than or equal to 2 ppm, preferably between 2 ppm and 0.0001 ppt, in particular between 0.3 ppm and 0.0001 ppt, preferably between 0.01 ppm and 0.0001 ppt, especially preferably between 1 ppb and 0.0001 ppt,
d. Iron less than or equal to 20 ppm, preferably between 10 ppm and 0.0001 ppt, in particular between 0.6 ppm and 0.0001 ppt, preferably between 0.05 ppm and 0.0001 ppt, especially preferably between 0.01 ppm and 0.0001 ppt, and quite especially preferably 1 ppb to 0.0001 ppt;
e. Nickel less than or equal to 10 ppm, preferably between 5 ppm and 0.0001 ppt, in particular between 0.5 ppm and 0.0001 ppt, preferably between 0.1 ppm and 0.0001 ppt, especially preferably between 0.01 ppm and 0.0001 ppt, and quite especially preferably between 1 ppb and 0.0001 ppt
f. Phosphorus less than 10 ppm to 0.0001 ppt, preferably between 5 ppm and 0.0001 ppt, in particular less than 3 ppm to 0.0001 ppt, preferably between 10 ppb and 0.0001 ppt and quite especially preferably between 1 ppb and 0.0001 ppt
g. Titanium less than or equal to 2 ppm, preferably less than or equal to 1 ppm to 0.0001 ppt, in particular between 0.6 ppm and 0.0001 ppt, preferably between 0.1 ppm and 0.0001 ppt, especially preferably between 0.01 ppm and 0.0001 ppt, and quite especially preferably between 1 ppb and 0.0001 ppt
h. Zinc less than or equal to 3 ppm, preferably less than or equal to 1 ppm to 0.0001 ppt, in particular between 0.3 ppm and 0.0001 ppt, preferably between 0.1 ppm and 0.0001 ppt, especially preferably between 0.01 ppm and 0.0001 ppt and quite especially preferably between 1 ppb and 0.0001 ppt,
   and a purity in the region of the limit of detection can be aimed at for each element, and the total contamination with the aforementioned elements should be less than 100 wt.-ppm, preferably less than 10 wt.-ppm, especially preferably less than 5 wt.-ppm in total in the silicon as direct method product from melting.

Especially preferably, the pure silicon obtained is suitable as solar-grade silicon.

A purified, pure or high-purity silicon oxide, in particular silicon dioxide, is characterized in that its content of:
a. Aluminium is preferably less than or equal to 5 ppm or between 5 ppm and 0.0001 ppt, in particular between 3 ppm and 0.0001 ppt, preferably between 0.8 ppm and 0.0001 ppt, especially preferably between 0.6 ppm and 0.0001 ppt, still better between 0.1 ppm and 0.0001 ppt, quite especially preferably between 0.01 ppm and 0.0001 ppt, and even more preferably 1 ppb to 0.0001 ppt,
b. Boron is below 10 ppm to 0.0001 ppt, in particular in the range from 5 ppm to 0.0001 ppt, preferably in the range from 3 ppm to 0.0001 ppt or especially preferably in the range from 10 ppb to 0.0001 ppt, even more preferably in the range from 1 ppb to 0.0001 ppt
c. Calcium is less than or equal to 2 ppm, preferably between 2 ppm and 0.0001 ppt, in particular between 0.3 ppm and 0.0001 ppt, preferably between 0.01 ppm and 0.0001 ppt, especially preferably between 1 ppb and 0.0001 ppt,
d. Iron is less than or equal to 20 ppm, preferably between 10 ppm and 0.0001 ppt, in particular between 0.6 ppm and 0.0001 ppt, preferably between 0.05 ppm and 0.0001 ppt, especially preferably between 0.01 ppm and 0.0001 ppt, and quite especially preferably 1 ppb to 0.0001 ppt;
e. Nickel is less than or equal to 10 ppm, preferably between 5 ppm and 0.0001 ppt, in particular between 0.5 ppm and 0.0001 ppt, preferably between 0.1 ppm and 0.0001 ppt, especially preferably between 0.01 ppm and 0.0001 ppt, and quite especially preferably between 1 ppb and 0.0001 ppt
f. Phosphorus is less than 10 ppm to 0.0001 ppt, preferably between 5 ppm and 0.0001 ppt, in particular less than 3 ppm to 0.0001 ppt, preferably between 10 ppb and 0.0001 ppt and quite especially preferably between 1 ppb and 0.0001 ppt
g. Titanium is less than or equal to 2 ppm, preferably less than or equal to 1 ppm to 0.0001 ppt, in particular between 0.6 ppm and 0.0001 ppt, preferably between 0.1 ppm and 0.0001 ppt, especially preferably between 0.01 ppm and 0.0001 ppt, and quite especially preferably between 1 ppb and 0.0001 ppt
h. Zinc is less than or equal to 3 ppm, preferably less than or equal to 1 ppm to 0.0001 ppt, in particular between 0.3 ppm and 0.0001 ppt, preferably between 0.1 ppm and 0.0001 ppt, especially preferably between 0.01 ppm and 0.0001 ppt and quite especially preferably between 1 ppb and 0.0001 ppt,
   and that the total of the aforementioned impurities plus sodium and potassium is less than 10, preferably less than 5 ppm, especially preferably less than 4 ppm, quite especially preferably less than 3 ppm, especially preferably 0.5 to 3 ppm and quite especially preferably 1 ppm to 3 ppm. And a purity in the region of the limit of detection can be aimed at for each element.

Pure or high-purity silicon carbide means a silicon carbide that can have, apart from silicon carbide, optionally also carbon and silicon oxide, such as Si_{y}O_{z} with y=1.0 to 20 and z=0.1 to 2.0, in particular as C-matrix and/or SiO₂-matrix or Si_{y}O_{z}-matrix with y=1.0 to 20 and z=0.1 to 2.0, and optionally small amounts of silicon. High-purity silicon carbide preferably means a corresponding silicon carbide with a passivation layer comprising silicon dioxide. High-purity silicon carbide can also mean a high-purity composition that contains or consists of silicon carbide, carbon, silicon oxide and optionally small amounts of silicon, and the high-purity silicon carbide or the high-purity composition has in particular an impurity profile for boron and phosphorus of below 100 ppm boron, in particular between 10 ppm and 0.001 ppt, and for phosphorus below 200 ppm, in particular between 20 ppm and 0.001 ppt phosphorus, in particular it has an overall impurity profile for boron, phosphorus, arsenic, aluminium, iron, sodium, potassium, nickel, chromium of below 100 wt.-ppm, preferably below 10 wt.-ppm, especially preferably below 5 wt.-ppm relative to the high-purity complete composition or the high-purity silicon carbide.

The impurity profile of the pure, preferably high-purity silicon carbide with boron, phosphorus, arsenic, aluminium, iron, sodium, potassium, nickel, chromium is, for each element, preferably below 5 ppm to 0.01 ppt (by weight), and for high-purity silicon carbide in particular below 2.5 ppm to 0.1 ppt. Especially preferably the silicon carbide obtained by the method according to the invention optionally with carbon and/or Si_{y}O_{z} matrices has the following content of:

Boron below 100 ppm, preferably between 10 ppm and 0.001 ppt, especially preferably from 5 ppm to 0.001 ppt or from below 0.5 ppm to 0.001 ppt and/or Phosphorus below 200 ppm, preferably between 20 ppm and 0.001 ppt, especially preferably from 5 ppm to 0.001 ppt or from below 0.5 ppm to 0.001 ppt and/or Sodium below 100 ppm, preferably between 10 ppm and 0.001 ppt, especially preferably from 5 ppm to 0.001 ppt or from below 1 ppm to 0.001 ppt and/or Aluminium below 100 ppm, preferably between 10 ppm and 0.001 ppt, especially preferably from 5 ppm to 0.001 ppt or from below 1 ppm to 0.001 ppt and/or Iron below 100 ppm, preferably between 10 ppm and 0.001 ppt, especially preferably from 5 ppm to 0.001 ppt or from below 0.5 ppm to 0.001 ppt and/or Chromium below 100 ppm, preferably between 10 ppm and 0.001 ppt, especially preferably from 5 ppm to 0.001 ppt or from below 0.5 ppm to 0.001 ppt and/or Nickel below 100 ppm, preferably between 10 ppm and 0.001 ppt, especially preferably from 5 ppm to 0.001 ppt or from below 0.5 ppm to 0.001 ppt and/or Potassium below 100 ppm, preferably between 10 ppm and 0.001 ppt, especially preferably from 5 ppm to 0.001 ppt or from below 0.5 ppm to 0.001 ppt and/or Sulphur below 100 ppm, preferably between 10 ppm and 0.001 ppt, especially preferably from 5 ppm to 0.001 ppt or from below 2 ppm to 0.001 ppt and/or Barium below 100 ppm, preferably between 10 ppm and 0.001 ppt, especially preferably from 5 ppm to 0.001 ppt or from below 3 ppm to 0.001 ppt and/or Zinc below 100 ppm, preferably between 10 ppm and 0.001 ppt, especially preferably from 5 ppm to 0.001 ppt or from below 0.5 ppm to 0.001 ppt and/or Zirconium below 100 ppm, preferably between 10 ppm and 0.001 ppt, especially preferably from 5 ppm to 0.001 ppt or from below 0.5 ppm to 0.001 ppt and/or Titanium below 100 ppm, preferably between 10 ppm and 0.001 ppt, especially preferably from 5 ppm to 0.001 ppt or from below 0.5 ppm to 0.001 ppt and/or Calcium below 100 ppm, preferably between 10 ppm and 0.001 ppt, especially preferably from 5 ppm to 0.001 ppt or from below 0.5 ppm to 0.001 ppt and in particular magnesium with below 100 ppm, preferably between 10 ppm and 0.001 ppt, especially preferably between 11 ppm and 0.001 ppt and/or copper below 100 ppm, preferably between 10 ppm and 0.001 ppt, especially preferably between 2 ppm and 0.001 ppt, and/or cobalt below 100 ppm, in particular between 10 ppm and 0.001 ppt, especially preferably between 2 ppm and 0.001 ppt, and/or vanadium below 100 ppm, in particular between 10 ppm and 0.001 ppt, preferably between 2 ppm and 0.001 ppt, and/or manganese below 100 ppm, in particular between 10 ppm and 0.001 ppt, preferably between 2 ppm and 0.001 ppt, and/or lead below 100 ppm, in particular between 20 ppm and 0.001 ppt, preferably between 10 ppm and 0.001 ppt, especially preferably between 5 ppm and 0.001 ppt.

An especially preferred pure to high-purity silicon carbide or a high-purity composition contains or consists of silicon carbide, carbon, silicon oxide and optionally small amounts of silicon, and the high-purity silicon carbide or the high-purity composition in particular has an impurity profile for boron, phosphorus, arsenic, aluminium, iron, sodium, potassium, nickel, chromium, sulphur, barium, zirconium, zinc, titanium, calcium, magnesium, copper, chromium, cobalt, zinc, vanadium, manganese and/or lead of below 100 ppm for pure silicon carbide, preferably of below 20 ppm to 0.001 ppt for high-purity silicon carbide, especially preferably between 10 ppm and 0.001 ppt relative to the high-purity complete composition or the high-purity silicon carbide.

According to the invention, the source of pure carbon, optionally containing at least one carbohydrate, or a mixture of sources of carbon has the following impurity profile: boron less than 2 [μg/g], phosphorus less than 0.5 [μg/g] and aluminium less than 2 [μg/g], preferably less than or equal to 1 [μg/g], in particular iron less than 60 [μg/g], preferably the iron content is less than 10 [μg/g], especially preferably less than 5 [μg/g]. On the whole, according to the invention it is desirable to use a source of pure carbon in which the content of impurities, such as boron, phosphorus, aluminium and/or arsenic, is below the respective technically possible limit of detection.

Preferably the pure or other source of carbon optionally comprising at least one carbohydrate, or the mixture of sources of carbon, has the following impurity profile for boron, phosphorus and aluminium and optionally for iron, sodium, potassium, nickel and/or chromium. Contamination with boron (B) is in particular between 5 and 0.000001 μg/g, preferably 3 to 0.00001 μg/g, especially preferably 2 to 0.00001 μg/g, according to the invention below 2 to 0.00001 μg/g. Contamination with phosphorus (P) is in particular between 5 and 0.000001 μg/g, preferably 3 to 0.00001 μg/g, especially preferably below 1 to 0.00001 μg/g, according to the invention below 0.5 to 0.00001 μg/g. Contamination with iron (Fe) is between 100 and 0.000001 μg/g, in particular between 55 and 0.00001 μg/g, preferably 2 to 0.00001 μg/g, especially preferably below 1 to 0.00001 μg/g, according to the invention below 0.5 to 0.00001 μg/g. Contamination with sodium (Na) is in particular between 20 and 0.000001 μg/g, preferably 15 to 0.00001 μg/g, especially preferably below 12 to 0.00001 μg/g, according to the invention below 10 to 0.00001 μg/g. Contamination with potassium (K) is in particular between 30 and 0.000001 μg/g, preferably 25 to 0.00001 μg/g, especially preferably below 20 to 0.00001 μg/g, according to the invention below 16 to 0.00001 μg/g.

Contamination with aluminium (Al) is in particular between 4 and 0.000001 μg/g, preferably 3 to 0.00001 μg/g, especially preferably below 2 to 0.00001 μg/g, according to the invention below 1.5 to 0.00001 μg/g. Contamination with nickel (Ni) is in particular between 4 and 0.000001 μg/g, preferably 3 to 0.00001 μg/g, especially preferably below 2 to 0.00001 μg/g, according to the invention below 1.5 to 0.00001 μg/g. Contamination with chromium (Cr) is in particular between 4 and 0.000001 μg/g, preferably 3 to 0.00001 μg/g, especially preferably below 2 to 0.00001 μg/g, according to the invention below 1 to 0.00001 μg/g. Minimal contamination with the respective elements, especially preferably below 10 ppb or below 1 ppb, is preferred.

### General Description of the Complete Method

The complete method comprises the reduction of a silicon dioxide purified by acidic precipitation with a carbon source for production of solar-grade silicon. Suitable carbon sources and method conditions are known to the person skilled in the art, for example from the above-cited prior art, especially US 2007/0217988 or U.S. Pat. No. 4,247,528. The content of these published specifications is hereby incorporated explicitly into the subject-matter of the present application.

According to the invention, in the overall method according to the invention for production of pure silicon, the silicon oxide purified by precipitation is formulated and reacted together with at least one source of pure carbon.

For example, moist or still moist silicon oxide can be formulated, extruded, pelletized, granulated or briquetted together with a pure carbohydrate. This formulation can be dried and can undergo a reduction step for the production of pure silicon or can first undergo an offline process step, pyrolysis and/or calcining for the production of pure carbon and/or silicon carbide.

Silicon carbide, in particular high-purity silicon carbide optionally comprising or containing a carbon matrix (C-matrix) or a silicon oxide matrix and/or optionally infiltrated with silicon may be used in the method according to the invention as activator and/or as source of pure carbon.

According to one embodiment the step of reduction for the production of pure silicon consists of reaction of the purified silicon oxide, in particular of the silicon dioxide, with a pure or high-purity silicon carbide, as defined previously or hereafter.

In specific embodiments, a silicon carbide and/or silicon, where the silicon carbide can comprise a C-matrix and/or a silicon oxide matrix and can be infiltrated with silicon, are added to the formulation, and the formulation alternatively
a) comprises the purified silicon oxide and at least one source of pure carbon and optionally silicon carbide and optionally silicon and/or
b) comprises the purified silicon oxide and optionally silicon carbide and optionally silicon and/or
c) comprises at least one source of pure carbon and optionally silicon carbide and optionally silicon,
   where the respective formulation can optionally contain binders and where the source of pure carbon can also comprise an activated carbon.

Purified silicon oxide, in particular purified silicon dioxide, such as silicic acid, pure carbon, in particular activated carbon and/or silicon carbide can be added to the process a) as powder, granules and/or as lumps and/or b) contained in a formulation for example in a porous glass, in particular quartz glass, in an extrudate and/or moulding, such as pellet or briquette, optionally together with other additives, in particular as binder and/or as second and further source of carbon. Activated carbon means a source of carbon with graphite fractions or a graphite. The graphite fraction in the source of carbon is preferably between 30 and 99 wt. % relative to the source of carbon, preferably the graphite fraction is 40 to 99 wt. %, especially preferably 50 to 99 wt. %.

Suitable methods for forming the formulation, in particular briquetting, such as extrusion, compression, tableting, pelletization, granulation and other well-known methods are well known to a person skilled in the art.

Other additives can be silicon oxides or a second source of carbon, in particular purified rice husks for example after washing and/or cooking with HCl, or mixtures of other sources of pure carbon, such as sugar, graphite, carbon fibres, and/or as binder and as second and further sources of carbon and/or silicon can be natural or synthetic resins, such as phenolic resin, functional silanes or siloxanes, technical alkylcelluloses, such as methylcellulose, polyethylene glycols, polyacrylates and polymethacrylates or mixtures of at least two of the aforementioned compounds. As functional silanes or siloxanes, we may mention for example—but not exclusively—: tetraalkoxysilanes, trialkoxysilanes, alkylsilicates, alkylalkoxysilanes, methacryloxyalkylalkoxysilanes, glycidyloxyalkylalkoxysilanes, polyetheralkylalkoxysilanes and corresponding hydrolysates or condensates or cocondensates from at least two of the aforementioned compounds, where “alkoxy” stands in particular for methoxy, ethoxy, propoxy or butoxy and “Alkyl” or “alkyl” stands for a mono- or divalent alkyl group with 1 to 18 carbon atoms, such as methyl, ethyl, n-propyl, butyl, isobutyl, pentyl, hexyl, heptyl, n-/i-octyl etc.; the following can be listed as examples: tetraethoxysilane, silanol, ethylsilicate, trimethoxysilane, methyltrimethoxysilane, dimethyldiethoxysilane, trimethylpropoxysilane, ethyltrimethoxysilane, methylethyldiethoxysilane, n-propyltriethoxysilane, n-/1-octyltrimethoxysilane, propylsilanol, octylsilanols and corresponding oligomers or condensates, 1-methacryloxymethyltrimethoxysilane, 2-methacryloxyethyltrimethoxysilane, 3-methacryloxypropyltrimethoxysilane, 3-methacryloxyisobutyltrimethoxysilane, 3-methacryloxypropylmethyldialkoxysilane, 3-methacryloxypropylsilanol and corresponding oligomers or condensates, 3-glycidyloxypropyltrimethoxysilane, 3-glycidyloxypropylsilanol and corresponding oligomers or condensates or hydrolysates, cocondensates or also block-co-condensates or cocondensates based on at least two from the series n-propyltriethoxysilane, n-/1-octyltriethoxysilane, 3-methacryloxypropyltrimethoxysilane, 3-glycidyloxypropyltrimethoxysilane and 3-polyetherpropyltriethoxysilane.

Said additives can simultaneously perform the function of a supplier of Si or C and that of a processing aid, in particular in the forming processes that are well known by a person skilled in the art, and/or the function of a binder, in particular of a binder that is substantially heat-resistant in the range from RT to 300° C. Preferably, for the production of granules, powders are sprayed with the binder in aqueous or alcoholic solution and then undergo a forming process, in which drying can take place simultaneously, or alternatively drying can also take place after forming. So that the process gases that formed during reduction to the pure silicon can flow well through the formulation, preferably highly porous tablets, pellets or briquettes are formed from the formulations.

The size of the briquettes is preferably in the range from 1 to 10 cm³, especially for a 500 kW furnace. The size is directly dependent on how the process is conducted. The forms can be adapted depending on the process and technical aspects, for example to be like gravel or shingle, a shingle-shaped briquette being preferred for feed through a pipe. A gravel may be of advantage in direct feed.

Preferred binders produce substantially dimensionally stable formulations in the temperature range from 150 to 300° C., and especially preferred binders produce dimensionally stable formulations in the temperature range between 200 and 300° C. In certain cases it may also be preferable to produce formulations that can provide substantially dimensionally stable formulations in the temperature range above 300° C. and up to 800° C. or higher, especially preferably up to 1400° C. These formulations can preferably be used in reduction to pure silicon. The high-temperature binders are based substantially on predominant Si—O substrate crosslinking, substrate generally meaning all components or functional groups of the formulation that can condense with silanol groups.

A preferred formulation comprises silicon carbide and/or activated carbon, for example graphite, or mixtures of these and another source of pure carbon, for example thermal black, and the stated heat-resistant binders, in particular high-temperature binders.

In general, all solid reactants, such as silicon dioxide, the source of pure carbon and optionally silicon carbide should be used in the process or should be present in the composition in a form that offers the maximum possible surface area for the reaction. According to the invention, a formulation in the form of a briquette is added. One or more sources of pure carbon, optionally in a mixture, an organic compound of natural origin, a carbohydrate, graphite (activated carbon), coke, coal, carbon black, thermal black, pyrolyzed carbohydrate, in particular pyrolyzed sugar, are used as the source of pure carbon in the method according to the invention. The sources of carbon, especially in pellet form, can for example be purified by treatment with hot hydrochloric acid solution. Additionally, an activator can be added to the method according to the invention. The activator can have the purpose of a reaction starter, a reaction accelerator as well as the purpose of the source of carbon. An activator is pure silicon carbide, silicon-infiltrated silicon carbide, and a pure silicon carbide with a C-matrix and/or silicon oxide matrix, for example a silicon carbide containing carbon fibres.

Alternatively the source of pure carbon consists of the activator, i.e. in the method according to the invention the activator is used as the sole source of carbon. Owing to this measure, the composition of the charge can be denser, because one mole equivalent of carbon monoxide gas in this step, reduction to silicon, is saved. Therefore the activator can be used in the method in catalytic amounts up to equimolar amounts in relation to the silicon oxide.

According to other alternatives, the activator can be used in the weight ratio from 1000:1 to 1:1000 to the source of pure carbon, the source of pure carbon being calculated without SiC, for example graphite, carbon black, carbohydrate, coal, coke. Preferably the source of carbon is used in the weight ratio from 1:100 to 100:1, especially preferably 1:100 to 1:9.

Reduction of the purified silicon oxide with one or more sources of pure carbon and/or the activator can take place in an industrial furnace, such as an arc furnace, in a thermal reactor, in an induction furnace, rotary kiln and/or in a microwave furnace, for example with fluidized bed and/or rotating tube.

In general, the reaction can be carried out in ordinary industrial furnaces for the production of silicon, for example melting furnaces for the production of silicon, such as metallurgical silicon, or other suitable melting furnaces, for example induction furnaces. The design of these melting furnaces, especially preferably electric furnaces, which use an electric arc as energy source, is well known by a person skilled in the art. In the case of direct-current furnaces they have a melting electrode and a bottom electrode or as alternating-current furnace usually three melting electrodes. The arc length is controlled by an electrode controller. Arc furnaces are based as a rule on a reaction space made of refractory material, at the bottom of which liquid silicon can be tapped or discharged. The raw materials are charged at the top, where the graphite electrodes for generating the arc are also arranged. These furnaces are generally operated at temperatures in the region of 1800° C. It is also known by a person skilled in the art that the furnace structure itself should not contribute to contamination of the silicon produced.

According to the invention, reduction of the purified silicon oxide takes place with one or more sources of pure carbon in a reaction space lined with high-purity refractories and optionally using electrodes that consist of high-purity material, as explained below. Ordinary electrodes are made of high-purity graphite and are consumed during the reduction process, so that as a rule they can be repositioned continuously.

The fused or molten silicon according to the invention obtained by reduction is obtained as molten pure silicon, in particular it is suitable as solar-grade silicon or is suitable for the production of solar-grade silicon, and optionally it is purified further by zone melting or by directional solidification, as is well known by a person skilled in the art.

Alternatively or additionally, the silicon can be solidified, comminuted and the comminuted fragments can be further classified on the basis of differences in magnetic behaviour. In particular the fraction enriched in impurities as a result of zone melting or directional solidification can then be used for the production of organosilanes. The method of magnetic classification is known as such by a person skilled in the art. For the magnetic classification of silicon from the reaction of purified silicon oxide and one or more sources of pure carbon, the complete disclosure contents of WO 03/018207 are made an object of the present application, with the modification that the silicon fed to magnetic separation originates from the reaction of purified silicon oxide and at least one source of pure carbon. A corresponding magnetic separation of the pure silicon produced according to the invention or a silicon further purified by zone melting of the pure silicon is an object of the invention.

The respective partial process steps taking place optionally, preferably in combination, for the complete method for the production of pure silicon, each of which, synergistically, makes a decisive contribution to the economic effectiveness of the complete method, are explained in more detail below.

### Description of the Production of the Silicon Oxide Purified by Precipitation

According to a main aspect of the method for the production of pure silicon according to the invention, a purified silicon dioxide from at least one silicate solution is used in the method for the production of pure silicon, in particular of solar-grade silicon.

The inventors found, surprisingly, that it is possible, by special process management in the precipitation and washing, to produce purified silicon dioxide, in particular high-purity silicon dioxide which can be used for the production of solar-grade silicon, simply, without a large number of additional upstream or downstream purification steps and without particular expenditure on equipment.

According to the invention, the precipitation of a silicon oxide dissolved in aqueous phase, in particular completely dissolved silicon oxide, is carried out with an acidifying agent. After reaction of the silicon oxide dissolved in aqueous phase with the acidifying agent, preferably by adding the silicon oxide dissolved in aqueous phase to the acidifying agent, a precipitation suspension is obtained.

An important characteristic of the method is the control of the pH value of the silicon dioxide and of the reaction media containing the silicon dioxide during the various process steps of the production of silicon dioxide.

According to the invention, the initial charge and the precipitation suspension, into which the silicon oxide dissolved in aqueous phase, in particular the water glass, is added, preferably dropwise, must always show an acid reaction. Acid means a pH value of below 6.5, in particular below 5.0, preferably below 3.5, especially preferably below 2.5, and according to the invention below 2.0 to below 0.5. It may be desirable to check the pH value to make sure that the pH value does not fluctuate too much, in order to obtain reproducible precipitation suspensions. If a constant or substantially constant pH value is desired, so the pH value should only show a range of variation of plus/minus 1.0, in particular of plus/minus 0.5, preferably of plus/minus 0.2.

In an especially preferred embodiment of the present invention the pH value of the precipitation suspension is always kept to less than 2, preferably less than 1, especially preferably less than 0.5. Furthermore it is preferable if the acid is always present in a definite excess to the alkali silicate solution, to ensure a pH value of the precipitation suspension of less than 2 at any time.

Without being bound to a particular theory, the inventors are of the view that a very low pH value ensures that no free, negatively charged SiO groups are present on the silicon dioxide surface, to which interfering metal ions can be attached.

At very low pH value, the surface is even positively charged, so that metal cations are repelled by the silicic acid surface. If these metal ions are now washed away, provided the pH value is very low they can be prevented from being deposited on the surface of the silicon dioxide according to the invention. If the silicic acid surface assumes a positive charge, silicic acid particles are additionally prevented from aggregating with consequent formation of cavities in which impurities could accumulate.

Especially preferably, and therefore as the main aspect, the present invention relates to a precipitation process for the production of purified silicon oxide, in particular high-purity silicon dioxide, comprising the following steps
a. Preparation of a feed from an acidifying agent with a pH value of less than 2, preferably less than 1.5, especially preferably less than 1, quite especially preferably less than 0.5
b. Preparation of a silicate solution, where in particular the viscosity, for the production of the silicon oxide purified by precipitation, can advantageously be adjusted in defined viscosity ranges, in particular a viscosity from 0.1 to 10 000 poise being preferred, and depending on the process parameters this viscosity range—as explained below—can be spread further, depending on other process parameters,
c. Addition of the silicate solution from step b. to the feed from step a., in such a way that the pH value of the precipitation suspension obtained always remains at a value of less than 2, preferably less than 1.5, especially preferably less than 1 and quite especially preferably less than 0.5
d. Separation and washing of the silicon dioxide obtained, the washing medium having a pH value of less than 2, preferably less than 1.5, especially preferably less than 1 and quite especially preferably less than 0.5
e. Drying of the silicon dioxide obtained

According to a first especially preferred variant of this method of the main aspect of the present invention, the invention relates to a precipitation process for the production of purified silicon oxide, in particular high-purity silicon dioxide, which is carried out with silicate solutions of low to medium viscosity i.e. step b is modified as follows:
b. Preparation of a silicate solution with a viscosity from 0.1 to 2 poise

According to a second especially preferred variant of this method of the main aspect of the present invention, the invention relates to a precipitation process for the production of purified silicon oxide, in particular high-purity silicon dioxide, which is carried out with silicate solutions of high or very high viscosity i.e. step b is modified as follows:
b. Preparation of a silicate solution with a viscosity from 2 to 100000 poise

In the different variants of the method contained as main aspect in the present invention, in step a) a feed is prepared from an acidifying agent or an acidifying agent and water in the precipitation vessel. The water is preferably distilled water or deionized water.

In all variants of the method according to the invention, not just the especially preferred embodiments described in detail above, the acidifying agents used may be organic or inorganic acids, preferably mineral acids, especially preferably hydrochloric acid, phosphoric acid, nitric acid, sulphuric acid, chlorosulphonic acid, sulphuryl chloride, perchloric acid, formic acid and/or acetic acid in concentrated or diluted form, or mixtures of the aforementioned acids. The aforementioned inorganic acids are especially preferred. Very especially preferred are hydrochloric acid, preferably 2 to 14 N, especially preferably 2 to 12 N, quite especially preferably 2 to 10 N, especially preferably 2 to 7 N and quite especially preferably 3 to 6 N, phosphoric acid, preferably 2 to 59 N, especially preferably 2 to 50 N, quite especially preferably 3 to 40 N, especially preferably 3 to 30 N and quite especially preferably 4 to 20 N, nitric acid, preferably 1 to 24 N, especially preferably 1 to 20 N, quite especially preferably 1 to 15 N, especially preferably 2 to 10 N, sulphuric acid, preferably 1 to 37 N, especially preferably 1 to 30 N, quite especially preferably 2 to 20 N, especially preferably 2 to 10 N. Quite especially preferably, concentrated sulphuric acid is used.

The acidifying agents can be used in a purity which is typically referred to as “technical grade”. It is clear to the person skilled in the art that the diluted or undiluted acidifying agents or mixtures of acidifying agents used should entrain a minimum level of impurities which do not remain dissolved in the aqueous phase of the precipitation suspension into the method. In each case, the acidifying agents should not have any impurities which would precipitate with the silicon oxide in the acidic precipitation, unless they could be kept in the precipitation suspension by means of added complexing agents or by pH control, or washed out with the later washing media.

The acidifying agent which is used for the precipitation may be the same as also used, for example, in step d, to wash the filter cake.

In a preferred variant of this method, in step a) a peroxide that produces a yellow/orange coloration with titanium(IV) ions in acidic conditions is added to the feed along with the acidifying agent. Especially preferably it is hydrogen peroxide or potassium peroxodisulphate. The yellow/orange coloration of the reaction solution can provide a very good indication of the degree of purification during the washing step d.

It has in fact been found that titanium is a very stubborn contaminant, which already attaches readily to silicon dioxide at pH values above 2. The inventors found that when the yellow coloration in stage d) disappears, as a rule the desired purity of the purified silicon oxide, in particular of the silicon dioxide, has been attained and from this point of time the silicon dioxide can be washed with distilled or deionized water until neutral pH of the silicon dioxide is reached. To achieve this indicator function of the peroxide, it is also possible to add the peroxide not in step a., but in step b. to the sodium silicate or in step c. as a third material stream. Basically it is also possible to add the peroxide also only after step c and before step d. or during step d.

All the aforementioned variants and mixed forms thereof are covered by the present inventions. However, the variants in which the peroxide is added in step a. or b. are preferred, as in this case it can perform another function in addition to the indicator function. Without being bound to a particular theory, the inventors are of the view that some—in particular carbon-containing—impurities can be oxidized by reaction with the peroxide and removed from the reaction solution. Other impurities are converted by oxidation to a more soluble form and can therefore be washed away. The precipitation process according to the invention therefore has the advantage that it is not necessary to carry out a calcining step, although this is of course optionally possible.

In all variants of the process according to the invention, the silicon dioxide dissolved in aqueous phase used is preferably an aqueous silicate solution, especially preferably an alkali and/or alkaline-earth silicate solution, very especially preferably a water glass. Such solutions can be obtained commercially, can be produced by liquefaction of solid silicates, can be produced from silicon dioxide and sodium carbonate or for example can be produced by the hydrothermal process directly from silicon dioxide and sodium hydroxide and water at elevated temperature. The hydrothermal process may be preferred over the soda process, because it can result in cleaner precipitated silicon dioxides. A disadvantage of the hydrothermal process is the limited range of ratios obtainable, for example the ratio of SiO₂ to N₂O is up to 2, the preferred ratios being 3 to 4, moreover the water glasses must as a rule be concentrated according to the hydrothermal process prior to precipitation. Generally the production of water glass as such is known by a person skilled in the art.

According to an alternative, an alkali water glass, in particular sodium water glass or potassium water glass, is optionally filtered and then concentrated if necessary. The filtration of the water glass or of the aqueous solution of dissolved silicates, in order to remove solid, undissolved constituents, can be carried out by processes that are known by a person skilled in the art and with devices that are known by a person skilled in the art.

The silicate solution used preferably has a ratio, i.e. weight ratio of metal oxide to silicon dioxide, from 1.5 to 4.5, preferably 1.7 to 4.2, especially preferably from 2 to 4.0.

The precipitation process according to the invention does not use chelating agents or ion-exchange columns. Calcining steps of the purified silicon oxide can also be omitted. Therefore the present precipitation process according to the invention is far simpler and more cost-effective than methods of the prior art. Another advantage of the precipitation process according to the invention is that it can be carried out in conventional equipment.

The use of ion exchangers for purification of the silicate solutions and/or acidifying agents before precipitation is not necessary, but may prove desirable depending on the quality of the aqueous silicate solutions. Therefore an alkaline silicate solution can also be pretreated in accordance with WO 2007/106860, in order to minimize the boron and/or phosphorus content beforehand. For this, the alkali silicate solution (aqueous phase in which silicon oxide is dissolved) can be treated with a transition metal, calcium or magnesium, a molybdenum salt or with an ion exchanger modified with molybdate salts to minimize the phosphorus content. Prior to the precipitation according to the method of WO 2007/106860, the alkali silicate solution can undergo the precipitation according to the invention in acid conditions, in particular at a pH value of less than 2. In the method according to the invention, however, preference is given to using acidifying agents and silicate solutions which have not been treated by means of ion exchangers before the precipitation.

In a specific embodiment, a silicate solution can be pretreated as silica sol according to the methods of EP 0 504 467 B1 before the actual acid precipitation according to the invention. For this, the entire disclosure of EP 0 504 467 B1 is expressly incorporated in the present document. The silica sol obtainable by the methods disclosed in EP 0 504 467 B1 is dissolved again completely, preferably after a treatment according to the methods of EP 0 504 467 B1, and then submitted to acid precipitation according to the invention, to obtain purified silicon oxide in accordance with the invention.

The silicate solution preferably has, before the acidic precipitation, a silicon dioxide content of, for instance, about 10% by weight or higher.

In the main aspect of the present invention, a silicate solution, especially a sodium water glass, used for the acidic precipitation has a viscosity of 0.1 to 10000 poise, preferably 0.2 to 5000 poise, more preferably 0.3 to 3000 poise, especially preferably 0.4 to 1000 poise (at room temperature, 20° C.).

In step b and c of the first preferred variant of the method of the main aspect, a silicate solution is prepared with a viscosity from 0.1 to 2 poise, preferably 0.2 to 1.9 poise, especially 0.3 to 1.8 poise and especially preferably 0.4 to 1.6 poise and quite especially preferably 0.5 to 1.5 poise. Mixtures of several silicate solutions can also be used.

In step b and c of the second preferred variant of the method of the main aspect, a silicate solution is prepared with a viscosity from 2 to 10000 poise, preferably 3 to 70000 poise, especially 4 to 6000 poise, especially preferably 4 to 1000 poise, quite especially preferably 4 to 100 poise and especially preferably 5 to 50 poise.

In step c of the main aspect and of the two preferred variants of the precipitation process according to the invention, the silicate solution from step b is added to the feed and the silicon dioxide is therefore precipitated. It is necessary to ensure that the acidifying agent is always present in excess. Addition of the silicate solution therefore takes place in such a way that the pH value of the reaction solution is always less than 2, preferably less than 1.5, especially preferably less than 1, quite especially preferably less than 0.5 and especially preferably is 0.01 to 0.5. Additional acidifying agent can be added if necessary. The temperature of the reaction solution is maintained, during addition of the silicate solution, at 20 to 95° C., preferably 30 to 90° C., especially preferably 40 to 80° C., by heating or cooling the precipitation vessel.

The inventors found that precipitates that can be filtered particularly easily are obtained if the silicate solution enters the feed and/or precipitation suspension in the form of droplets. Therefore in a preferred embodiment of the present invention care is taken to ensure that the silicate solution enters the feed and/or precipitation suspension in the form of droplets. This can for example be achieved by adding the silicate solution dropwise to the feed. This can involve a metering device arranged outside of the feed/precipitation suspension and/or dipping into the feed/precipitation suspension.

In the first especially preferred variant of the method of the main aspect, i.e. the method with low-viscosity water glass, it proved particularly advantageous if the feed/precipitation suspension is set in motion, for example by stirring or pumping, in such a way that the flow velocity measured in a region that is delimited by half the radius of the precipitation vessel ±5 cm and the surface of the reaction solution to 10 cm below the reaction surface, is from 0.001 to 10 m/s, preferably 0.005 to 8 m/s, especially preferably 0.01 to 5 m/s, quite especially 0.01 to 4 m/s, especially preferably 0.01 to 2 m/s and quite especially preferably 0.01 to 1 m/s.

Without being bound to a particular theory, the inventors are of the view that because of the low flow velocity, there is very little distribution of the incoming silicate solution immediately after it enters the feed/precipitation suspension. As a result, gelling occurs rapidly on the outer shell of the incoming silicate solution droplets or silicate solution streams, before impurities can be enclosed inside the particles. Through optimum selection of the of the flow velocity of the feed/precipitation suspension it is therefore possible to improve the purity of the product obtained.

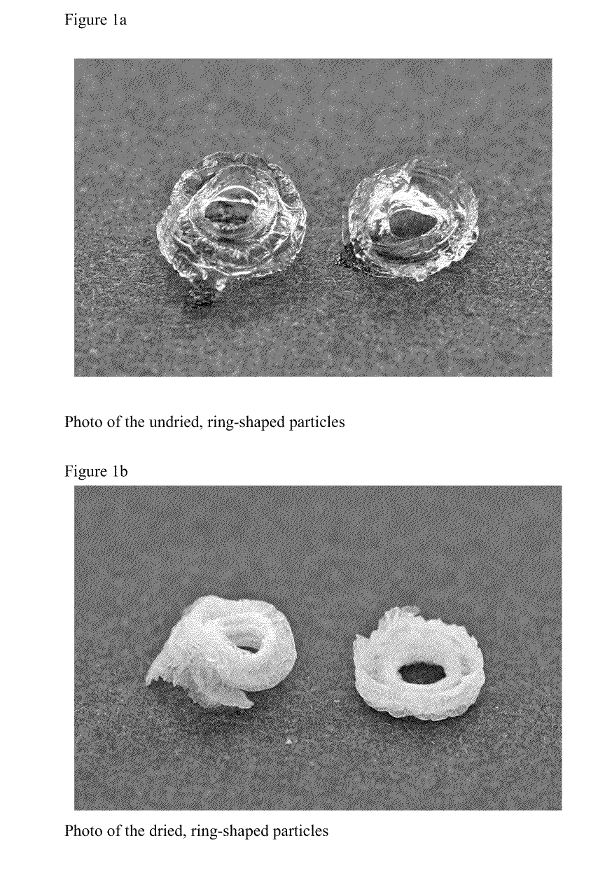

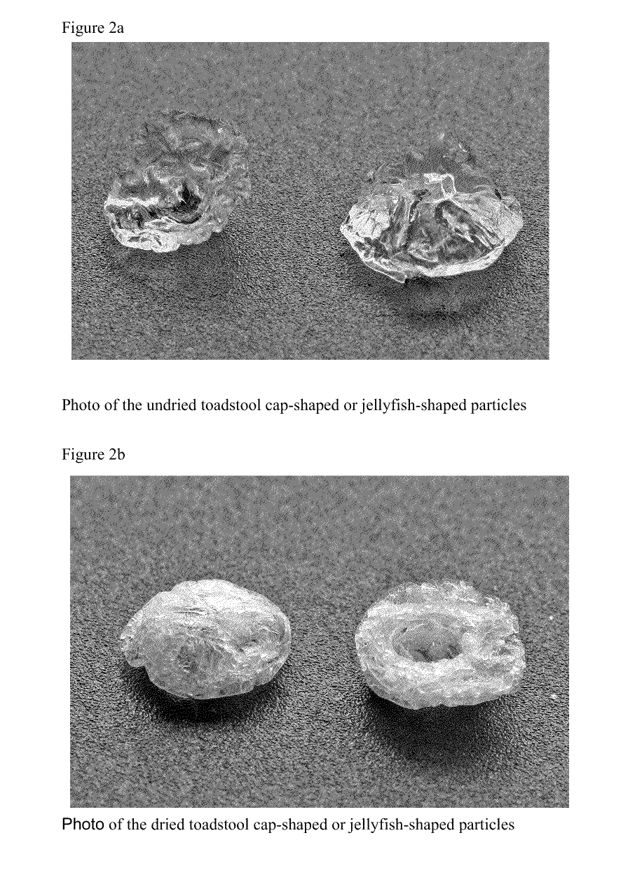

By combining an optimized flow velocity with introduction of the silicate solution as far as possible in the form of droplets, this effect can be further enhanced, so that an embodiment of the method according to the invention, in which the silicate solution is introduced in droplet form into a feed/precipitation suspension at a flow velocity, measured in a region d which is delimited by half the radius of the precipitation vessel ±5 cm and the surface of the reaction solution to 10 cm below the reaction surface, from 0.001 to 10 m/s, preferably 0.005 to 8 m/s, especially preferably 0.01 to 5 m/s, quite especially 0.01 to 4 m/s, especially preferably 0.01 to 2 m/s and quite especially preferably 0.01 to 1 m/s. In this way it is moreover possible to produce silicon dioxide particles that can be filtered very easily (see FIGS. 1 and 2). In contrast, in methods in which there is a high flow velocity in the feed/precipitation suspension, very fine particles are formed, said particles are very difficult to filter.

In the second preferred embodiment of the main aspect of the present invention, i.e. in the case of use of high-viscosity water glass, particularly pure and easily filterable precipitates likewise form as a result of dropwise addition of the silicate solution. Without being bound to a particular theory, the inventors are of the view that the high viscosity of the silicate solution, together with the pH value, means that after step c) an easily filtered precipitate is formed and that there is little if any accumulation of impurities in the internal cavities of the silicon dioxide particles, because owing to the high viscosity the droplet shape of the dropwise-added silicate solution is largely retained and the droplet is not finely distributed before the gelling/crystallization begins on the surface of the droplet. An alkali and/or alkaline-earth silicate solution can be used as silicate solution, preferably an alkali silicate solution, especially preferably sodium silicate (water glass) and/or potassium silicate solution is used. Mixtures of several silicate solutions can also be used. Alkali silicate solutions have the advantage that the alkali ions can easily be separated by washing. The viscosity can be adjusted e.g. by concentration of commercially available silicate solutions by evaporation, or by dissolving the silicates in water.

As stated above, by suitable choice of viscosity of the silicate solution and/or of the stirring speed, the filterability of the particles can be improved, because particles with a special shape are obtained. The present invention therefore relates to purified silicon oxide particles, in particular silicon dioxide particles preferably with an outside diameter from 0.1 to 10 mm, especially preferably 0.3 to 9 mm and quite especially preferably 2 to 8 mm. In a first special embodiment of the present invention said silicon dioxide particles have an annular shape, i.e. have a “hole” in the middle (see FIG. 1a) and their shape can therefore be compared to a miniature “doughnut”. The ring-shaped particles can be of a substantially round shape, but also a rather oval shape.

In a second special embodiment of the present precipitation process according to the invention the silicon dioxide particles have a shape that is comparable to a “toadstool cap” or a “jellyfish”, i.e. instead of the hole of the “doughnut”-shaped particle described above, in the middle of the annular main structure there is a preferably thin, i.e. thinner than the annular part, layer of silicon dioxide that is domed on one side (see FIG. 2a), stretched over the internal opening of the “ring”. If we put these particles on the ground with the domed side downward and view them vertically from above, the particles correspond to a dish with a domed bottom, a rather massive, i.e. thick upper edge and a somewhat thinner bottom in the region of the dome.

Without being bound to a particular theory, the inventors are of the view that the acid conditions in the feed/reaction solution together with the dropwise addition of the silicate solution, plus the viscosity and the flow velocity of the feed/precipitation suspension, have the effect that the droplets of the silicate solution start to gel/precipitate on their surface immediately on contact with the acid, and at the same time the droplet is deformed through the motion of the droplet in the reaction solution/feed. Depending on the reaction conditions, apparently the “toadstool cap”-shaped particles form with slower motion of the droplets, whereas the “doughnut”-shaped particles are formed with faster motion of the droplets.

The present invention also relates to a precipitation process in which, after step c, the silicon dioxide particles the previously described silicon dioxide particles of the embodiments “doughnuts” and “toadstool caps” are produced or processed further in at least one step.

The silicon dioxide obtained after precipitation, i.e. in the main aspect and the preferred variants of the main aspect as step c., is separated in from the other constituents of the precipitation suspension (in the main aspect and the preferred variants of the main aspect step d). Depending on the filterability of the precipitate, this can be carried out by conventional filtration techniques known by a person skilled in the art, e.g. with filter presses or rotary filters. In the case of precipitates with poor filterability, separation can also be carried out by centrifugation and/or by decanting off the liquid constituents of the precipitation suspension.

After separation from the supernatant, the precipitate is washed, ensuring, with a suitable washing medium, that the pH of the washing medium during washing, and thus also of the purified silicon oxide, in particular silicon dioxide, is less than 2, preferably less than 1.5, especially preferably less than 1, quite especially preferably 0.5 and especially preferably 0.01 to 0.5.

The washing media can preferably be aqueous solutions of organic and/or inorganic water-soluble acids, e.g. the aforementioned acids or fumaric acid, oxalic acid, formic acid, acetic acid or other organic acids known by a person skilled in the art, which themselves do not contribute to contamination of the purified silicon oxide, if they cannot be removed completely with high-purity water. Generally, therefore, all organic, water-soluble acids, in particular consisting of the elements C, H and O, are preferred both as acidifying agent and as in the washing medium, because they themselves do not contribute to contamination of the subsequent reduction step. The acidifying agent used in step a. and c. or mixtures thereof in diluted or undiluted form are preferably used.

The washing medium can if required also comprise a mixture of water and organic solvents. Suitable solvents are high-purity alcohols, such as methanol and ethanol, possible esterification does not interfere with the subsequent reduction to silicon.

The aqueous phase preferably does not contain any organic solvents, such as alcohols, and/or any organic, polymeric substances.

In the method according to the invention it is not usually necessary to add chelating agents to the precipitation suspension or during the purification. Nevertheless, the present invention also includes methods in which, for stabilization of acid-soluble metal complexes, a metal complexing agent, such as EDTA, is added to the precipitation suspension or to a washing medium. Optionally it is therefore possible to add a chelating agent to the washing medium or to stir the precipitated silicon dioxide in a washing medium with corresponding pH value of less than 2, preferably less than 1.5, especially preferably less than 1, quite especially preferably 0.5 and especially preferably 0.01 to 0.5, containing a chelating agent. Preferably, however, washing with the acidic washing medium takes place immediately after the separation of the silicon dioxide precipitate, without further steps being carried out.

It is also possible to add a peroxide for colour marking, as an “indicator” of undesirable metallic impurities. For example, hydroperoxide can be added to the precipitation suspension or the washing medium, in order to indicate, by colour, the presence of titanium impurities. Marking is in general also possible with other organic complexing agents, which for their part do not cause interference in the subsequent reduction process. Generally this includes all complexing agents based on the elements C, H and O, and the element N can also be added advantageously in the complexing agent. For example for the formation of silicon nitride, which advantageously decomposes again in the subsequent process.

Washing is continued until the silicon dioxide has the desired purity. This can be recognized, for example, when the wash suspension contains a peroxide and no longer has a visible yellow coloration. If the precipitation process according to the invention is carried out without addition of a peroxide that forms a yellow/orange coloured compound with Ti(IV) ions, then in each washing step a small sample of the wash suspension can be taken and a corresponding peroxide must be added to it. This process is continued until the sample taken no longer gives a visible yellow/orange coloration after adding the peroxide. It is necessary to ensure that the pH value of the washing medium and thus also that of the purified silicon oxide, in particular silicon dioxide, up to this point of time is less than 2, preferably less than 1.5, especially preferably less than 1, quite especially preferably 0.5 and especially preferably is 0.01 to 0.5.

The silicon dioxide thus washed and purified, is washed further preferably with distilled water or deionized water, until the pH value of the silicon dioxide obtained is in the range 4 to 7.5 and/or the conductivity of the wash suspension is less than or equal to 9 μS/cm, preferably less than or equal to 5 μS/cm. This ensures that any acid residues adhering to the silicon dioxide have been adequately removed.

Separation can be carried out with usual measures that are well known by a person skilled in the art, such as filtration, decanting, centrifugation, and sedimentation, provided that the impurity level of acid-precipitated, purified silicon oxide is not made worse again by these measures.

For precipitates with poor filterability it may be advantageous to carry out washing by having the washing medium flowing from below onto the precipitate in a fine-meshed strainer basket.

The purified silicon dioxide, in particular high-purity silicon dioxide thus obtained can be dried and processed further. Drying can be carried out by all methods known by a person skilled in the art, e.g. with band dryers, shelf dryers, drum dryers etc.

It is recommended to grind the dried silicon dioxide, to obtain an optimum range of particle size for further processing to solar-grade silicon. The techniques for optional grinding of the silicon dioxide according to the invention are known by a person skilled in the art and can be found for example in Ullmann, 5th edition, B2, 5-20. Preferably the grinding is carried out in fluidized-bed countercurrent mills in order to minimize or avoid contamination of the high-purity silicon dioxide with metal abraded from the mill walls. The grinding parameters are selected such that the particles obtained have an average particle size d₅₀ of 1 to 100 μm, preferably 3 to 30 μm, especially preferably 5 to 15 μm.

The silicon oxides prepared and purified in accordance with the invention preferably have the profile of impurities defined above for purified, pure or high-purity silicon dioxide, but they may also have the following amounts of impurities:
a. Aluminium between 0.001 ppm and 5 ppm, preferably 0.01 ppm to 0.2 ppm, especially preferably 0.02 to 0.1, quite especially preferably 0.05 to 0.8 and especially preferably 0.1 to 0.5 ppm,
b. Boron less than 1 ppm, preferably 0.001 ppm to 0.099 ppm, especially preferably 0.001 ppm to 0.09 ppm and quite especially preferably 0.01 ppm to 0.08 ppm
c. Calcium less than or equal to 1 ppm, 0.001 ppm to 0.3 ppm, especially preferably 0.01 ppm to 0.3 ppm and quite especially preferably 0.05 to 0.2 ppm
d. Iron less than or equal to 5 ppm, preferably 0.001 ppm to 3 ppm, especially preferably 0.05 ppm to 3 ppm and quite especially preferably 0.01 to 1 ppm, especially preferably 0.01 ppm to 0.8 ppm and quite especially preferably 0.05 to 0.5 ppm
e. Nickel less than or equal to 1 ppm, preferably 0.001 ppm to 0.8 ppm, especially preferably 0.01 ppm to 0.5 ppm and quite especially preferably 0.05 ppm to 0.4 ppm
f. Phosphorus less than 10 ppm, preferably less than 5, especially preferably less than 1, quite especially preferably 0.001 ppm to 0.099 ppm, especially preferably 0.001 ppm to 0.09 ppm and quite especially preferably 0.01 ppm to 0.08 ppm
g. Titanium less than or equal to 1 ppm, 0.001 ppm to 0.8 ppm, especially preferably 0.01 ppm to 0.6 ppm and quite especially preferably 0.1 to 0.5 ppm
h. Zinc less than or equal to 1 ppm, preferably 0.001 ppm to 0.8 ppm, especially preferably 0.01 ppm to 0.5 ppm and quite especially preferably 0.05 ppm to 0.3 ppm
   the sum of the aforementioned impurities plus sodium and potassium being less than 10 ppm, preferably less than 4 ppm, especially preferably less than 3 ppm, quite especially preferably 0.5 to 3 ppm and especially preferably 1 ppm to 3 ppm.

The high-purity silicon dioxides according to the invention can be in the previously described presentation forms, i.e. as “doughnut”-shaped particles or as “toadstool cap”-shaped particles or in conventional particle shapes. However, they can also be ground, compressed to granules or briquettes by methods known by a person skilled in the art. If the particles have been ground, i.e. they are in the conventional particle form, they can preferably have an average particle size d₅₀ of 1 to 100 μm, especially preferably 3 to 30 μm and quite especially preferably 5 to 15 μm. The “doughnut”-shaped or “toadstool cap”-shaped particles preferably have an average particle size d₅₀ of 0.1 to 10 mm, especially preferably 0.3 to 9 mm and quite especially preferably 2 to 8 mm.

The purified silicon oxides, in particular high-purity silicon dioxides, are processed further according to the invention to pure to high-purity silicon for the solar power industry, or a portion thereof is alternatively used as described below. According to the invention, the purified silicon oxides, in particular high-purity silicon dioxides, are reacted with a source of pure carbon, such as a high-purity carbon, silicon carbide and/or pure sugars.

The method according to the invention does not usually comprise a calcining step for the silicon dioxide. However, this does not rule out the possibility that the silicon oxide obtained can be submitted to a thermal post-treatment, in particular a calcining treatment, preferably at temperatures between 900 and 2000° C., especially preferably around 1400° C., in order to remove nitrogen-containing and sulphur-containing impurities.

The purified silicon oxide obtainable by precipitation according to the invention, in particular the purified silicon dioxide has a content of the elements aluminium, boron, calcium, iron, nickel, phosphorus, titanium and/or zinc each separately or in combination, as was defined above and preferably has better filterability.

In an alternative embodiment of the method described above for the production of high-purity silicon oxide it is also possible to convert contaminated silicon oxide to a dissolved form and for example produce a high-purity silicon dioxide from this solution by the aforementioned method.

Therefore the invention also relates to the use of at least one silicon oxide containing impurities for the production of silicon, suitable in particular as solar-grade silicon or suitable for the production of solar-grade silicon, preferably of pure silicon according to the above definition, comprising the following steps,
I) conversion of the silicon oxide containing impurities to a silicate dissolved in aqueous phase, in particular to an aqueous silicate solution,
II) addition of the silicate dissolved in aqueous phase, in particular the aqueous silicate solution, to an aqueous, acidic solution, with the impurities remaining in solution, in particular the pH value and/or the addition is selected so that as far as possible all the impurities remain in solution from the start of addition up to the end of addition, and a precipitate of purified silicon dioxide is obtained.

Another object is a method by which the silicon oxide thus obtained—as described in detail below—in step
III) is converted to silicon in the presence of at least one or more sources of carbon and optionally by addition of an activator.

In particular step II) takes place in accordance with the above account for the production of a precipitation suspension, preferably acid precipitation takes place in aqueous solution optionally in the presence of pure solvents, with the unwanted impurities remaining dissolved in the acidic, aqueous solution. The pH value is preferably below pH=2, as stated above.

A silicon oxide containing impurities is considered to be a silicon oxide with a content of boron, phosphorus, aluminium, iron, titanium, sodium and/or potassium of greater than 1000 wt.-ppm, in particular greater than 100 wt.-ppm, preferably a silicon oxide is still regarded as contaminated silicon oxide if the overall content of the above impurities is above 10 wt.-ppm.

A “silicon oxide containing impurities” also means a silicon dioxide with a content of the following elements each individually or in any partial combinations or also all together of:
a. Aluminium above 6 ppm, in particular above 5.5 ppm, also preferably still above 5 ppm, also especially preferably still above 0.85 ppm and/or
b. Boron above 10 ppm, also preferably still above 5.5 ppm, especially preferably above 3.5, quite especially preferably still above 15 ppb and/or
c. Calcium above 2 ppm, in particular also still above 0.35 ppm, especially preferably still above 0.025 ppm and/or
d. Iron above 23 ppm, in particular above 15 ppm, preferably still above 0.65 ppm and/or
e. Nickel above 15 ppm, in particular above 5.5 ppm, especially preferably still above 0.055 ppm and/or
f. Phosphorus above 15 ppm, in particular above 5.5 ppm, especially preferably still above 0.1 ppm, or also still above 15 ppb and/or
g. Titanium above 2.5 ppm, in particular above 1.5 ppm and/or
h. Zinc above 3.5 ppm, in particular above 1.5 ppm, especially preferably still above 0.35 ppm,
   and in particular the sum of the aforementioned impurities plus sodium and potassium is greater than 10 ppm, also in particular still above 5 ppm, preferably above 4 ppm, especially preferably above 3 ppm, quite especially preferably above 1 ppm or also still above 0.5 ppm.

Also at a boron content of less than 0.5 ppm, also in particular still below 0.1 ppm and/or a phosphorus content of above 1 ppm or also still above 0.5 ppm, a silicon oxide is regarded as silicon oxide containing impurities if only the content of at least one element selected from the group aluminium, calcium, iron, nickel, titanium, zinc exceeds the limit stated above.

The silicon oxide purified by all the methods described in detail above, especially the high-purity silicon dioxide, can be used as a starting material in the further method according to the invention. It can be used for further conversion to high-purity silicon, i.e. the reduction step, but it can also be used in one process variant as a high-purity antifoaming agent in the production of high-purity carbon. This process variant is described below. The silicon oxide purified by all the processes described in detail above can also be used to produce silicon carbide, which is described below.

### Production of the Carbon Source by Sugar Pyrolysis Using Silicon Oxide as an Antifoaming Agent

In addition to the other carbon sources mentioned in this description, preferably the natural carbon sources listed therein, it is also possible to obtain carbon from carbohydrates. To produce the high-purity carbon, in this preferred variant (method component) of the complete method according to the invention for preparing pure silicon, it is preferable to use a carbon source, especially a pure carbon source, in which the carbon is obtained by industrial pyrolysis of at least one carbohydrate or of a carbohydrate mixture, especially of a crystalline sugar, at elevated temperature with addition of silicon oxide.

It was found, surprisingly, that by adding silicon oxide, preferably SiO₂, in particular precipitated silicic acid and/or pyrogenically produced silicic acid, the foam forming effect can be suppressed.

Since this step involves essentially the production of pure carbon and only a very small amount of silicon oxide need be added, it is not absolutely necessary to use a silicon oxide obtained by the method component described in detail above, although this is preferred for process simplification. In one variant, for example, the high-purity silicon oxide obtained by the above-described method component can be used together with a carbon source, especially a pure carbon source, and chlorine for the known reaction to give halogenated silanes. These silanes can be used to produce ultrahigh-purity pyrogenic silicic acids.

This industrial process for pyrolysis of carbohydrates can be operated simply and economically and without unwanted foam formation. Furthermore, when carrying out the method only a short caramel phase was observed. Furthermore, in a preferred embodiment it was advantageous, as it is especially energy-saving (low-temperature mode), to lower the pyrolysis temperature from for example 1600° C. to about 700° C. The method is carried out advantageously above a temperature of 400° C., preferably between 800 and 1600° C., especially preferably between 900 and 1500° C., in particular at 1000 to 400° C., and advantageously a graphite-containing pyrolysis product is obtained.

If a graphite-containing pyrolysis product is preferred, pyrolysis temperatures from 1300 to 1500° C. are desirable. Pyrolysis is carried out advantageously under protective gas and/or reduced pressure (vacuum). For example at a pressure from 1 mbar to 1 bar (ambient pressure), in particular from 1 to 10 mbar. The substances used in particular do not need drying in pyrolysis with a microwave furnace. The educts can have a residual moisture. Advantageously, pyrolysis equipment used is dried before the start of pyrolysis and purged almost completely of oxygen by flushing with an inert gas, such as nitrogen or Ar or He. Preferably argon or helium is used. The pyrolysis time is as a rule between 1 minute and 48 hours, preferably between ¼ hour and 18 hours, in particular between. Hour and 12 hours at said pyrolysis temperature, and the heating time for reaching the desired pyrolysis temperature can additionally be of the same order, in particular between ¼ hour and 8 hours.

The method is as a rule carried out as a batch process; it can, however, also be carried out continuously.

A C-based pyrolysis product obtained contains coal, in particular with graphite fractions and silicic acid and optionally fractions of other forms of carbon, such as coke, and is especially low in impurities, for example B, P, As and Al compounds. Thus, the pyrolysis product can be used advantageously as reducing agent in the complete method according to the invention. In particular, on the basis of its conductivity properties, the graphite-containing pyrolysis product can be used in an arc reactor.

The present invention therefore relates to a method for technical, i.e. industrial pyrolysis of a carbohydrate or carbohydrate mixture at elevated temperature with addition of silicon oxide, in particular purified silicon oxide.

Preferably monosaccharides are used as carbohydrate component in the pyrolysis, i.e. aldoses or ketoses, such as trioses, tetroses, pentoses, hexoses, heptoses, especially glucose and fructose, but also corresponding oligo- and polysaccharides based on said monomers, such as lactose, maltose, sucrose, raffinose,—to mention just a few or their derivatives—as well as starch, including amylose and amylopectin, the glycogens, the glycosans and fructosans,—to mention just a few polysaccharides. However, all carbohydrates/sugars described in detail below for the production of SiC can be used in the purities mentioned there.

Optionally the aforementioned carbohydrates can additionally be purified by a treatment using an ion exchanger, dissolving the carbohydrate in a suitable solvent, advantageously water, passing it through a column packed with an ion-exchange resin, preferably an ionic or cationic resin, the resultant solution is concentrated, for example by removing solvent fractions by heating—in particular under reduced pressure—and the carbohydrate thus purified is advantageously obtained in crystalline form, for example by cooling the solution and subsequent separation of the crystalline fractions, e.g. by filtration or centrifugation. However, a mixture of at least two of the aforementioned carbohydrates can also be used as carbohydrate or carbohydrate component in pyrolysis.

Especially preferably, a crystalline sugar that is available in economic quantities is used, a sugar such as can be obtained for example by crystallization of a solution or a juice from sugar cane or sugar beet in a well-known manner, i.e. commercially available crystalline sugar, for example refined sugar, preferably a crystalline sugar with the substance-specific melting point/softening range and an average particle size from 1 μm to 10 cm, especially preferably from 10 μm to 1 cm, in particular from 100 μm to 0.5 cm. The particle size can be determined for example—but not exclusively—by sieve analysis, TEM, SEM or light microscopy. It is also possible to use a carbohydrate in dissolved form, for example—but not exclusively—in aqueous solution, with the solvent being evaporated readily and more or less quickly before the actual pyrolysis temperature is reached.

The silicon oxide component used in pyrolysis is preferably SiO with x=0.5 to 1.5, SiO, SiO₂, silicon oxide (hydrate), aqueous or water-containing SiO₂, e.g. in the form of pyrogenic or precipitated silicic acid, moist, dry or calcined, for example Aerosil® or Sipernat®, or a silicic acid sol or gel, porous or dense vitreous silica, quartz sand, quartz glass fibres, for example optical fibres, quartz glass beads, or mixtures of at least two of the aforementioned components. Silicic acid with an internal surface from 0.1 to 600 m²/g, especially preferably from 10 to 500 m²/g, in particular from 100 to 200 m²/g, is preferably used for pyrolysis. The internal or specific surface can be determined for example by the BET method (DIN ISO 9277). Preferably silicic acid is used with an average particle size from 10 nm to 5 1 mm, in particular from 1 to 500 μm. The particle size can also be determined here inter alia by TEM (transmission electron microscopy), SEM (scanning electron microscopy) or light microscopy. Very especially preferably, a silicon oxide obtained by the method components described above is used.

The silicic acid used in pyrolysis is, advantageously, of high (99%) to ultrahigh (99.9999%) purity, and the total content of impurities, such as B, P, As and Al compounds, should be advantageously ≦10 wt.-ppm, preferably ≦5 wt.-ppm, especially preferably ≦2 wt.-ppm and quite especially preferably 1 to 0.001 wt.-ppm. In a special embodiment the impurity content of the aforementioned elements is ≦0.5 wt.-ppm to 0.0001 wt.-ppb. According to the invention, purified silicon oxide is used, i.e. silicic acid that was precipitated at a pH value below 2. Especially preferably, in the pyrolysis, a purified silicon oxide, especially high-purity silicon oxide, according to the definition given at the start of this description is used, and very especially preferably silicon dioxide prepared by the purification method according to the invention. The impurities can be determined for example—but not exclusively—by ICPMS/OS (induction coupled spectrometry—mass spectrometry/optical electron spectrometry) and AAS (atomic absorption spectroscopy) or GDMS (glow-discharge mass spectrometry).

Thus, during pyrolysis it is possible to use carbohydrate to antifoaming agent, i.e. silicon oxide component, calculated as SiO₂, in a weight ratio from 1000:0.1 to 0.1:1000. Preferably the weight ratio of carbohydrate component to silicon oxide component can be set at 100:1 to 1:100, especially preferably at 50:1 to 1:50, quite especially preferably at 20:1 to 1:20, in particular at 2:1 to 1:1.

The equipment used for carrying out pyrolysis can be for example an induction-heated vacuum reactor, the reactor possibly being made of special steel and, in view of the reaction, coated or lined with a suitable inert substance, for example with high-purity SiC, Si₃N₃, high-purity quartz glass or vitreous silica, high-purity carbon or graphite.

However, other suitable reaction vessels can also be used, for example an induction furnace with vacuum chamber for receiving a corresponding reaction crucible.

Pyrolysis is generally carried out as follows:

The interior of the reactor and the reaction vessel are dried in a suitable manner and flushed with an inert gas, which can for example be heated to a temperature between room temperature and 300° C. Then the carbohydrate or carbohydrate mixture to be pyrolyzed is fed, along with the silicon oxide as antifoaming component, into the reaction space or reaction vessel of the pyrolysis equipment. The substances used can be mixed intimately beforehand, degassed under reduced pressure and transferred under protective gas into the prepared reactor. The reactor can already have been lightly preheated. Then the temperature can be raised continuously or in stages to the desired pyrolysis temperature, reducing the pressure so that the gaseous decomposition products released from the reaction mixture can be led away as quickly as possible. It is advantageous to avoid foaming of the reaction mixture as far as possible, in particular by adding silicon oxide.

On completion of the pyrolysis reaction, the pyrolysis product can undergo a thermal post-treatment for some time, advantageously at a temperature in the range from 1000 to 1500° C. As a rule this gives a pyrolysis product or a composition that contains pure to high-purity carbon. According to the invention the pyrolysis product is preferably used as reducing agent for the production of solar-grade silicon in the complete method.

For this, the pyrolysis product can be brought to a defined form with addition of further components, in particular with addition of SiO₂ purified according to the invention, activators, such as SiC, binders, such as organosilanes, organosiloxanes, carbohydrates, silica gel, natural or synthetic resins, and high-purity processing aids, such as pressing, tableting or extrusion auxiliaries, such as graphite, bring to a defined form, for example by granulation, pelletization, tableting, extrusion—to give just a few examples.

The present invention therefore also relates to a composition or to the pyrolysis product, as obtained after pyrolysis. Therefore the present invention also relates to a pyrolysis product with a content of carbon to silicon oxide (calculated as silicon dioxide) from 400 to 0.1 to 0.4 to 1000, in particular 400:0.4 to 4:10, preferably from 400:2 to 4:1.3, especially preferably from 400:4 to 40:7.

In particular the direct pyrolysis product is characterized by its high purity and usability for the production of polycrystalline silicon, in particular of solar-grade silicon for photovoltaic installations, but also for medical applications.

Said composition (also called pyrolysate or pyrolysis product for short) can be used according to the invention as raw material in the production of solar-grade silicon by reduction of SiO₂, in particular by reduction of the purified silicon oxide, at high temperature, in particular in an arc furnace. According to the invention the direct method product will be used for reaction of purified silicon oxide with a source of pure carbon in the method according to the invention. Alternatively, it is also possible to use the direct method product simply and economically as C-containing reducing agent in a method of the stated documents, as can be found for example in U.S. Pat. No. 4,247,528, U.S. Pat. No. 4,460,556, U.S. Pat. No. 4,294,811 and WO 2007/106860.

The present invention also relates to the use of a composition (pyrolysis product) as raw material in the production of solar-grade silicon by reduction of SiO₂, in particular by reduction of the purified silicon oxide, at high temperature, in particular in an arc furnace.

Production of High-Purity Sic from SiO₂ and its Use in the Method According to the Invention

Another aspect according to the invention of the complete method for the production of pure silicon encompasses the use of silicon carbide as activator and/or as a source of pure carbon, in which case the silicon carbide must be a pure silicon carbide. First the production of silicon carbide, in particular for use in the method according to the invention for the production of pure silicon, is thus explained below, and then a method in which the silicon carbide is used as activator, reaction starter, reaction accelerator or also as source of pure carbon in the production of silicon.

Generally the silicon carbide can be purchased and/or can be silicon carbide for recycling or reject product, provided it meets the purity requirements for this method. Thus, the pure silicon carbide can be obtained by reacting silicon oxide and a source of carbon comprising at least one carbohydrate at elevated temperature and can be used in the method according to the invention, for example, as material for the production of the electrodes or the high-purity refractories for lining the reactors, in particular the first layer of the reaction space or of the reactor. This aspect will be explained elsewhere below. Crystalline sugar is preferably used as a source of carbon comprising at least one carbohydrate, in particular a source of pure carbon.

According to this partial aspect of the invention, a method is disclosed for the production of pure to high-purity silicon carbide and/or silicon carbide/graphite particles by reacting silicon oxide, in particular purified silicon oxide, and a source of carbon comprising a carbohydrate, in particular carbohydrates, at elevated temperature, in particular a commercial process for the production of silicon carbide or for the production of compositions containing silicon carbide and isolation of the reaction products. Moreover, this partial aspect of the invention relates to a pure to high-purity silicon carbide, compositions containing the latter, use as catalyst and use in the production of electrodes or as material of electrodes and other articles.

In accordance with the partial aspect of the invention, one of its aims is to produce pure to high-purity silicon carbide from clearly more favourable raw materials, and overcome the existing process-related disadvantages of the known methods, which separate hydrolysis sensitive and self-igniting gases to silicon carbide.

It was found, surprisingly, that by reacting mixtures of silicon dioxide, in particular of silicon oxide purified in accordance with the invention, and sugar with subsequent pyrolysis and/or high temperature calcining, depending on the mixture ratio, a high-purity silicon carbide in a carbon matrix and/or silicon carbide in a silicon dioxide matrix and/or a silicon carbide, comprising carbon and/or silicon dioxide in a composition, can be produced cost-effectively. Preferably the silicon carbide is produced in a carbon matrix. In particular a silicon carbide particle with an external carbon matrix, preferably with a graphite matrix on the internal and/or external surface of the particle, can be obtained.

The silicon carbide can be obtained simply, in pure form, by passive oxidation with air, in particular by removing the carbon oxidatively. Alternatively, the silicon carbide can be further purified and/or separated by sublimation at high temperatures and optionally under high vacuum. Silicon carbide sublimes at temperatures around 2800° C.

Silicon carbide can be obtained in pure form by post-treatment of the silicon carbide in a carbon matrix by passive oxidation with oxygen, air and/or NOₓ.H₂O, for example at temperatures around 800° C. In this oxidation process, carbon or the carbon-containing matrix can be oxidized and can be removed as process gas from the system, for example as carbon monoxide. The purified silicon carbide then possibly still comprises one or more silicon oxide matrices or possibly small amounts of silicon.

Silicon carbide itself is relatively resistant to oxidation by oxygen at temperatures above 800° C. In direct contact with oxygen, it forms a passivating layer of silicon dioxide (SiO₂, “passive oxidation”). At temperatures above about 1600° C. and with simultaneous oxygen deficiency (partial pressure below approx. 50 mbar) there is formation of gaseous SiO, not the glass-like SiO₂; there is no longer a protective effect, and the SiC is quickly burnt (“active oxidation”). This active oxidation occurs when the free oxygen in the system is exhausted.

A C-based reaction product or a reaction product with carbon matrix, in particular a pyrolysis product, obtained according to the invention contains carbon, in particular in the form of coke and/or carbon black, and silicic acid and possibly fractions of other forms of carbon, such as graphite, and is especially low in impurities, for example the elements boron, phosphorus, arsenic, iron and aluminium and their compounds.

The pyrolysis and/or calcination product can preferably be used as reducing agent in the production of silicon carbide from sugar coke and silicic acid at high temperature. In particular the carbon-containing or graphite-containing pyrolysis and/or calcination product according to the invention is used, on account of its conductivity properties, for the production of the electrodes according to the invention and for the production of the electrodes of the reactor according to the invention, in particular as electrode material. For example in an arc reactor, or as catalyst and according to the invention as raw material for the production of pure silicon, in particular for the production of solar-grade silicon. The silicon carbide obtainable can also be used for the production of the high-purity refractories for lining the reactors, a reaction space or for lining other fittings, feed lines or discharge lines.

The high-purity silicon carbide can also be used as an energy source and/or as additive for the production of high-purity steels.

The present invention therefore relates to a method for the production of pure to high-purity silicon carbide by reacting silicon oxide, in particular purified silicon oxide according to the above definition, in particular purified silicon dioxide, and a source of carbon comprising at least one carbohydrate, in particular a source of pure carbon, at elevated temperature, and in particular isolation of the silicon carbide. The invention also relates to a silicon carbide or a composition containing silicon carbide obtainable by this method and the pyrolysis and/or calcination product obtainable by the method according to the invention, and in particular isolation thereof.

The invention relates to a commercial, preferably a large-scale commercial process for industrial reaction or industrial pyrolysis and/or calcining of a pure carbohydrate or carbohydrate mixture at elevated temperature with addition of silicon oxide, in particular purified silicon dioxide, and their conversion. According to an especially preferred variant of the method, the commercial process for the production of high-purity silicon carbide consists of the reaction of pure carbohydrates, optionally of carbohydrate mixtures, with silicon oxide, in particular purified silicon dioxide, and silicon oxide formed in-situ, at elevated temperature, in particular between 400 and 3000° C., preferably at 1400 to 1800° C., especially preferably between about 1450 and below about 1600° C.

According to the invention, a pure to high-purity silicon carbide is isolated optionally with a carbon matrix and/or silicon oxide matrix or a matrix comprising carbon and/or silicon oxide, in particular it is isolated as product, optionally silicon-containing. The isolated silicon carbide can have any crystalline phase, for example an α- or β-silicon carbide phase or mixtures of these or other silicon carbide phases. All together, more than 150 polytypic phases of silicon carbide are generally known. Preferably the pure to high-purity silicon carbide obtained by the method contains little if any silicon or is only infiltrated with silicon to a slight extent, in particular in the range from 0.001 and 60 wt. %, preferably between 0.01 and 50 wt. %, especially preferably between 0.1 and 20 wt. % relative to the silicon carbide contain said matrices and optionally silicon. According to the invention, as a rule no silicon forms during the calcining or high-temperature reaction, because there is no agglomeration of the particles and as a rule a melt is not formed. Silicon would not form unless a melt forms. The further content of silicon can be controlled by infiltration with silicon.

Pure or high-purity silicon carbide means a silicon carbide as was defined at the start of the description under “Definitions”.

The pure to high-purity silicon carbides or high-purity compositions can be obtained by using the reactants, the carbohydrate-containing source of carbon and the silicon oxide used, as well as the reactors, reactor components, pipework, storage tanks for the reactants, the reactor lining, jacketing and optionally added reaction gases or inert gases with the necessary purity in the method according to the invention.

The pure to high-purity silicon carbide or the high-purity composition according to the above definition, in particular including a content of carbon; for example in the form of coke, carbon black, graphite; and/or silicon oxide, in particular in the form of SiO₂, or preferably in the form of products of reaction of the purified silicon oxide, has a profile of contamination with boron and/or phosphorus or with boron-containing and/or phosphorus-containing compounds, which for the element boron is preferably below 100 ppm, in particular between 10 ppm and 0.001 ppt, and for phosphorus below 200 ppm, in particular between 20 ppm and 0.001 ppt. Preferably the boron content in a silicon carbide is between 7 ppm and 1 ppt, preferably between 6 ppm and 1 ppt, especially preferably between 5 ppm and 1 ppt or lower, or for example between 0.001 ppm and 0.001 ppt, preferably in the region of the limit of analytical detection. The phosphorus content in a silicon carbide should preferably be between 18 ppm and 1 ppt, preferably between 15 ppm and 1 ppt, especially preferably between 10 ppm and 1 ppt or lower. The phosphorus content is preferably in the region of the limit of analytical detection. Figures in ppm, ppb and/or ppt are to be understood throughout as proportions by weight, in particular in mg/kg, μg/kg, ng/kg or in mg/g, μg/g or ng/g etc.

According to the invention, carbohydrates or saccharides; or mixtures of carbohydrates or suitable derivatives of carbohydrates, are used in the method according to the invention as the source of carbon comprising at least one carbohydrate, in particular a source of pure carbon. The naturally occurring carbohydrates, anomers of these, invert sugar and synthetic carbohydrates can be used. It is also possible to use carbohydrates that have been obtained biotechnologically, for example by fermentation. Preferably the carbohydrate or derivative is selected from a monosaccharide, disaccharide, oligosaccharide or polysaccharide or a mixture of at least two of the stated saccharides. Especially preferably, the following carbohydrates are used in the method: monosaccharides, i.e. aldoses or ketoses, such as trioses, tetroses, pentoses, hexoses, heptoses, especially glucose and fructose, as well as oligo- and polysaccharides based on said monomers, such as lactose, maltose, sucrose, raffinose, to name just a few, and it is also possible to use derivatives of the stated carbohydrates, provided they meet the stated purity requirements—even including cellulose, cellulose derivatives, starch, including amylose and amylopectin, glycogen, the glycosans and fructosans, to mention just a few polysaccharides. However, a mixture of at least two of the aforementioned carbohydrates can also be used as carbohydrate or carbohydrate component in the method according to the invention.

Generally it is possible to use all carbohydrates, derivatives of carbohydrates and carbohydrate mixtures in the method according to the invention, which are preferably of sufficient purity, in particular with respect to the elements boron, phosphorus and/or aluminium. The sum total of the stated elements as impurities in the carbohydrate or the mixture should be below 100 μg/g, in particular below 100 μg/g to 0.001 μg/g, preferably below 10 μg/g to 0.001 μg/g, especially preferably below 5 μg/g to 0.01 μg/g. The carbohydrates to be used according to the invention consist of the elements carbon, hydrogen and oxygen and optionally have the stated impurity profile.

Carbohydrates consisting of the elements carbon, hydrogen, oxygen and nitrogen optionally with the aforementioned impurity profile can be used advantageously in the method, if a doped silicon carbide or a silicon carbide containing silicon nitride is to be produced. For the production of silicon carbide containing silicon nitride, where in this case the silicon nitride is not regarded as an impurity, chitin can also be used advantageously in the method.

Other carbohydrates available on an industrial scale are lactose, hydroxypropylmethylcellulose (HPMC) and other usual tableting excipients, which can optionally be used for formulation of the silicon oxide with the usual crystalline sugars.

A crystalline sugar that is available in economic amounts, a sugar such as can be obtained for example by crystallization of a solution or from a juice from sugar cane or sugar beet by well-known methods, i.e. commercially available crystalline sugar, in particular food-grade crystalline sugar, is especially preferred in the method according to the invention. The sugar or the carbohydrate can, provided the impurity profile is suitable for the method, naturally generally also be used in the method in liquid form, as syrup, in the solid phase, i.e. also amorphous. Optionally a formulation and/or drying step is then carried out beforehand.

The sugar can also have been purified beforehand with ion exchangers in the liquid phase, optionally in demineralized water or another suitable solvent or solvent mixture, optionally for removing particular impurities, which are less easily separated by crystallization. The ion exchangers can be strongly acid, weakly acid, amphoteric, neutral or basic ion exchangers. Selection of the appropriate ion exchanger, according to the impurities to be removed, will be familiar as such to a person skilled in the art. Next, the sugar can be crystallized, centrifuged and/or dried or mixed with silicon oxide and dried. Crystallization can take place by cooling or addition of an anti-solvent or by other techniques that are familiar to a person skilled in the art. The crystalline components can be separated by filtration and/or centrifugation.

According to the invention, the source of carbon containing at least one carbohydrate, or the carbohydrate mixture, in particular a source of pure carbon, has the following impurity profile: boron less than 2 [μg/g], phosphorus less than 0.5 [μg] and aluminium less than 2 [μg/g], preferably less than or equal to 1 [μg/g], in particular iron less than 60 [μg/g], preferably the content of iron is below 10 [μg/g], especially preferably below 5 [μg/g]. On the whole, according to the invention it is desirable to use carbohydrates in which the content of impurities, such as boron, phosphorus, aluminium and/or arsenic etc., is below the respective technically possible limit of detection.

Preferably the carbohydrate source comprising at least one carbohydrate, according to the invention the carbohydrate or the carbohydrate mixture, has the following profile of contamination with boron, phosphorus and aluminium and optionally with iron, sodium, potassium, nickel and/or chromium. Contamination with boron (B) is in particular between 5 and 0.00001 μg/g, preferably 3 to 0.00001 μg/g, especially preferably 2 to 0.00001 μg/g, according to the invention below 2 to 0.00001 μg/g. Contamination with phosphorus (P) is in particular between 5 and 0.00001 μg/g, preferably 3 to 0.00001 μg/g, especially preferably below 1 to 0.00001 μg/g, according to the invention below 0.5 to 0.00001 μg/g. Contamination with iron (Fe) is between 100 and 0.00001 μg/g, in particular between 55 and 0.00001 μg/g, preferably 2 to 0.00001 μg/g, especially preferably below 1 to 0.00001 μg/g, according to the invention below 0.5 to 0.00001 μg/g. Contamination with sodium (Na) is in particular between 20 and 0.00001 μg/g, preferably 15 to 0.00001 μg/g, especially preferably below 12 to 0.00001 μg/g, according to the invention below 10 to 0.00001 μg/g. Contamination with potassium (K) is in particular between 30 and 0.00001 μg/g, preferably 25 to 0.00001 μg/g, especially preferably below 20 to 0.00001 μg/g, according to the invention below 16 to 0.00001 μg/g. Contamination with aluminium (Al) is in particular between 4 and 0.00001 μg/g, preferably 3 to 0.00001 μg/g, especially preferably below 2 to 0.00001 μg/g, according to the invention below 1.5 to 0.00001 μg/g. Contamination with nickel (Ni) is in particular between 4 and 0.00001 μg/g, preferably 3 to 0.00001 μg/g, especially preferably below 2 to 0.00001 μg/g, according to the invention below 1.5 to 0.00001 μg/g. Contamination with chromium (Cr) is in particular between 4 and 0.00001 μg/g, preferably 3 to 0.00001 μg/g, especially preferably below 2 to 0.00001 μg/g, according to the invention below 1 to 0.00001 μg/g.

According to the invention, a crystalline sugar, for example refined sugar, is used or a crystalline sugar is mixed with a water-containing silicon dioxide or a silicic acid sol, dried and used in particulate form in the method. Alternatively any carbohydrate, in particular sugar, invert sugar or syrup is mixed with a dry, water-containing or aqueous silicon oxide, silicon dioxide, a silicic acid containing water or a silicic acid sol or the silicon oxide components stated below, optionally dried and used in the method as particles, preferably with a particle size from 1 nm to 10 mm.

Usually sugar with an average particle size of 1 nm to 10 cm, in particular 10 μm to 1 cm, preferably 100 μm to 0.5 cm is used. Alternatively sugar with an average particle size in the micrometre to millimetre range can be used, the range from 1 micrometre to 1 mm, especially preferably 10 micrometres to 100 micrometres being preferred. Particle size can be determined for instance by sieve analysis, TEM (transmission electron microscopy), SEM (scanning electron microscopy) or light microscopy. A dissolved carbohydrate can also be used as liquid, syrup, or paste, evaporating the high-purity solvent prior to pyrolysis. Alternatively a drying step can be included for solvent recovery.

Preferred raw materials as a source of carbon, in particular as a source of pure carbon, are moreover all organic compounds known by a person skilled in the art that comprise at least one carbohydrate and satisfy the purity requirements, for example solutions of carbohydrates. The carbohydrate solution used can also be an aqueous-alcoholic solution or a solution containing tetraethoxysilane (Dynasylan® TEOS) or a tetraalkoxysilane, the solution being evaporated and/or pyrolyzed before the pyrolysis proper.

The silicon oxide or silicon oxide component used is preferably an SiO, especially preferably an SiO with x=0.5 to 1.5, SiO, SiO₂, silicon oxide (hydrate), aqueous or water-containing SiO₂, a silicon oxide in the form of pyrogenic or precipitated silicic acid, moist, dry or calcined, for example Aerosil® or Sipernat®, or a silicic acid sol or gel, porous or dense vitreous silica, quartz sand, quartz glass fibres, for example optical fibres, quartz glass beads, or mixtures of at least two of the aforementioned forms of silicon oxide. The particle sizes of the individual components are adjusted to one another in a manner known by a person skilled in the art.

Within the scope of the present invention, “sol” means a colloidal solution, in which the solid or liquid substance is dispersed in extremely fine distribution in a solid, liquid or gaseous medium (see also Römpp Chemie Lexikon [Römpp's Dictionary of Chemistry]). The particle size of the source of carbon comprising a carbohydrate and the particle size of the silicon oxide are in particular adjusted to one another, in order to provide good homogenization of the components and prevent demixing before or during the process.

Preferably a porous silicic acid is used, in particular with an internal surface from 0.1 to 800 m²/g, preferably from 10 to 500 m²/g or from 100 to 200 m²/g, and in particular with an average particle size of 1 nm or larger or also from 10 nm to 10 mm, in particular silicic acid of high (99.9%) to ultrahigh (99.9999%) purity, total content of impurities, such as B, P, As and Al compounds, advantageously being less than 10 wt.-ppm relative to the total composition. The purity is determined by sample analysis known by a person skilled in the art, for example by detection in ICP-MS (analysis for the determination of trace impurities). Electron-spin spectrometry can provide particularly sensitive detection. The internal surface can for example be determined using the BET method (DIN ISO 9277, 1995).

A preferred average particle size of the silicon oxide is in the range 10 nm to 1 mm, in particular from 1 to 500 μm. The particle size can be determined for instance by TEM (transmission electron microscopy), SEM (scanning electron microscopy) or light microscopy.

As suitable silicon oxides, generally consideration may be given to all compounds and/or minerals containing a silicon oxide, provided they are of a purity suitable for the method and hence for the product from the method and do not introduce unwanted elements and/or compounds into the process or do not burn without residues. As stated above, compounds or materials containing pure or high-purity silicon oxide are used in the method.

According to the invention, a purified silicon oxide, corresponding to the above definition and/or produced in accordance with the partial method described above, is especially preferably used in the method for the production of silicon carbide.

When using the various silicon oxides, in particular the various silicas, silicic acids etc., agglomeration during pyrolysis may vary depending on the pH value of the particle surface. Generally, with silicon oxides that are rather acid, we observe intensified agglomeration of the particle as a result of pyrolysis. Therefore, for the production of pyrolysates and/or calcining products with little agglomeration it may be preferable to use silicon oxides with neutral to basic surfaces in the method, for example with pH values between 7 and 14.

According to the invention, silicon oxide comprises a silicon dioxide, in particular a pyrogenic or precipitated silicic acid, preferably a pyrogenic or precipitated silicic acid of high or highest purity, according to the invention a purified silicon oxide. “Highest purity” means a silicon oxide, in particular a silicon dioxide in which the contamination of the silicon oxide with boron and/or phosphorus or for boron-containing and/or phosphorus-containing compounds for boron should be less than 10 ppm, in particular between 10 ppm and 0.0001 ppt, and for phosphorus should be less than 20 ppm, in particular between 10 ppm and 0.0001 ppt. The boron content is preferably between 7 ppm and 1 ppt, preferably between 6 ppm and 1 ppt, especially preferably between 5 ppm and 1 ppt or lower, or for example between 0.001 ppm and 0.001 ppt, preferably in the region of the limit of analytical detection. The phosphorus content of the silicon oxides should preferably be between 18 ppm and 1 ppt, preferably between 15 ppm and 1 ppt, especially preferably between 10 ppm and 1 ppt or lower. The phosphorus content is preferably in the region of the limit of analytical detection.

Silicon oxides such as quartz, quartzite and/or silicon dioxides produced in the usual way are also advantageous. These can be the silicon dioxides occurring in crystalline modifications, such as morganite (chalcedony), α-quartz (low quartz), β-quartz (high quartz), tridymite, cristobalite, coesite, stishovite or also amorphous SiO₂, in particular, if they satisfy the stated purity requirements. Moreover, silicic acids, in particular precipitated silicic acids or silica gels, pyrogenic SiO₂, pyrogenic silicic acid or silica can preferably be used in the method and/or the composition. Usual pyrogenic silicic acids are amorphous SiO₂ powders on average from 5 to 50 nm in diameter and with a specific surface from 50 to 600 m²/g. The above list is not to be understood as final, it is obvious to a person skilled in the art that other silicon oxide sources that are suitable for the method can also be used in the method, if the silicon oxide source is of appropriate purity or is after it has been purified.

The silicon oxide, in particular SiO₂ supplied and/or used can be pulverulent, granular, porous, foamed, as extrudate, as moulding and/or as porous glasses optionally together with other additives, in particular together with the source of carbon comprising at least one carbohydrate and optionally a binder and/or moulding aid.

A pulverulent, porous silicon dioxide is preferably used as formed material, in particular as extrudate or moulding, especially preferably together with the source of carbon comprising a carbohydrate in an extrudate or moulding, for example in a pellet or briquette. In general, all solid reactants, such as silicon dioxide, and optionally the source of carbon comprising at least one carbohydrate should be used in the method or should be in a composition, in a form that offers a largest possible surface for occurrence of the reaction. In addition, increased porosity is desirable for rapid removal of the process gases. Therefore a particulate mixture of silicon dioxide particles coated with carbohydrate can be used according to the invention. This particulate mixture is in particular packaged, in an especially preferred embodiment, as a composition or kit.

The amounts of materials used as well as the respective proportions of silicon oxide, in particular silicon dioxide and the source of carbon comprising at least one carbohydrate are based on circumstances or requirements known by a person skilled in the art, for example in a subsequent process for silicon production, sintering process, process for production of electrode material or electrodes.

In the method according to the invention, the carbohydrate can be used in a weight ratio of carbohydrate to silicon oxide, in particular of silicon dioxide, in a weight ratio from 1000:0.1 to 1:1000 relative to the total weight. Preferably the carbohydrate or the carbohydrate mixture is used in a weight ratio to the silicon oxide, in particular the silicon dioxide, from 100:1 to 1:100, especially preferably from 50:1 to 1:5, quite especially preferably from 20:1 to 1:2, with preferred range from 2:1 to 1:1. According to a preferred embodiment, carbon is used in the method, via the carbohydrate, in excess relative to the silicon to be reacted in the silicon oxide. If the silicon oxide is used in excess in an advantageous embodiment, when selecting the ratio it is necessary to ensure that the formation of silicon carbide is not suppressed.

Also according to the invention, the carbon content of the source of carbon comprising a carbohydrate to the silicon content of the silicon oxide, in particular of the silicon dioxide, is in a molar ratio from 1000:0.1 to 0.1:1000 relative to the total composition. When using usual crystalline sugars, the preferred range of moles of carbon, introduced via the source of carbon comprising a carbohydrate, to moles of silicon, introduced via the silicon oxide compound, is in the range from 100 mol:1 mol to 1 mol:100 mol (C to Si in the educts), especially preferably C to Si is in a ratio from 50:1 to 1:50, quite especially preferably from 20:1 to 1:20, according to the invention in the range from 3:1 to 2:1 or up to 1:1. Molar ratios are preferred in which the carbon is added via the source of carbon in approximately equimolar proportions or in excess to the silicon in the silicon oxide.

The method component is usually designed as a multistage process. A first step comprises pyrolysis of the source of carbon comprising at least one carbohydrate in the presence of silicon oxide with graphitization, in particular there is formation on and/or in the silicon oxide component, such as SiOx with x=0.5 to 1.5, SiO, SiO₂, silicon oxide (hydrate), carbon-containing pyrolysis products, for example coatings containing fractions of graphite and/or carbon black. Pyrolysis is followed by calcining. The pyrolysis and/or calcining can take place successively in one reactor or separately from one another in different reactors. For example, pyrolysis takes place in a first reactor, and the subsequent calcining for example in a fluidized-bed microwave furnace. A person skilled in the art is aware that the reactor fittings, vessels, feed and/or discharge lines, and furnace fittings themselves must not contribute to contamination of the method products.

The method component is in general designed so that the silicon oxide and the source of carbon comprising at least one carbohydrate, intimately mixed, dispersed, homogenized or in a formulation, are fed to a first reactor for pyrolysis. This can take place continuously or discontinuously. Optionally the substances used are dried before they are fed into the reactor proper, preferably adhering water or residual moisture can remain in the system. The complete technical and industrial method component is divided into a first phase, in which pyrolysis takes place, and another phase, in which calcining takes place. The reaction can take place at temperatures starting from 150° C., preferably starting from 400 up to 3000° C., with, in a first pyrolysis step (low-temperature mode) a reaction taking place at lower temperatures, in particular at 400 to 1400° C. and a subsequent calcining at higher temperatures (high-temperature mode), in particular at 1400 to 3000° C., preferably at 1400 to 1800° C. The pyrolysis and calcining can take place immediately after one another in one process, or in two separate steps. For example, the method product from pyrolysis can be packaged as a composition and used later by a further processor for the production of silicon carbide or silicon.

Alternatively, the reaction of silicon oxide, in particular purified silicon oxide and the source of carbon comprising a carbohydrate, in particular the source of pure carbon, can begin with a low temperature range, for example starting from 150° C., preferably at 400° C. and be increased continuously or stepwise for example up to 1800° C. or higher, in particular around 1900° C. This procedure can be favourable for leading away the process gases that form.

According to another alternative process mode, the reaction can take place directly at high temperatures, in particular at temperatures above 1400° C. to 3000° C., preferably between 1400° C. and 1800° C., especially preferably between 1450 and below about 1600° C. In order to stop decomposition of the silicon carbide that has formed, in the case of low-oxygen atmosphere the reaction is preferably carried out at temperatures below the decomposition temperature, in particular below 1800° C., preferably below 1600° C. The method product isolated according to the invention is high-purity silicon carbide as defined below.

Pyrolysis proper (low-temperature step) takes place as a rule at temperatures below about 800° C. Depending on the desired product, pyrolysis can be carried out at normal pressure, in vacuum or also at increased pressure. If working in vacuum or at low pressure, the process gases can be led away easily and highly porous, particulate structures are obtained after pyrolysis. Under conditions in the region of normal pressure there is usually increased agglomeration of the porous, particulate structures. If pyrolysis is carried out at increased pressures, the volatile reaction products may condense on the silicon oxide particles and possibly react with one another or with reactive groups of the silicon dioxide. For example, decomposition products of the carbohydrates that form, such as ketones, aldehydes or alcohols, may react with free hydroxyl groups of the silicon dioxide particles. This greatly reduces pollution of the environment with the process gases. The porous pyrolysis products obtained are in this case somewhat more agglomerated.

As well as pressure and temperature, which can be selected freely over a wide range depending on the desired pyrolysis product, and for which the precise adjustment to one another is well known by a person skilled in the art, the pyrolysis of the source of carbon containing at least one carbohydrate can in addition be carried out in the presence of moisture, in particular of residual moisture of the educts, or by adding moisture, in the form of condensed water, steam or hydrate-containing components, such as SiO₂.nH₂O, or other hydrates familiar to a person skilled in the art. The presence of moisture in particular has the effect that the carbohydrate undergoes pyrolysis more readily, and that expensive pre-drying of the educts can be omitted. Especially preferably, the method for the production of silicon carbide is carried out by reacting silicon oxide, in particular purified silicon oxide, and a source of carbon comprising at least one carbohydrate, in particular a source of pure carbon, at elevated temperature especially at the start of pyrolysis in the presence of moisture, optionally moisture is also added or fed in during pyrolysis.

As a rule, pyrolysis takes place, in particular in the at least one first reactor, in the low-temperature mode around 700° C., usually between 200° C. and 1600° C., especially preferably between 300° C. and 1500° C., in particular at 400 to 1400° C., preferably a graphite-containing pyrolysis product being obtained. Preferably the internal temperature of the reactants is regarded as the pyrolysis temperature. The pyrolysis product is preferably obtained at temperatures around 1300 to 1500° C.

The method is as a rule carried out in the low-pressure range and/or under inert gas atmosphere. Argon or helium are preferred as inert gas. Nitrogen may also be advantageous, or if optionally silicon nitride is to form in addition to silicon carbide or n-doped silicon carbide in the calcining step, which may be desirable depending on how the process is conducted. In order to produce n-doped silicon carbide in the calcining step, nitrogen can be added to the process in the pyrolysis and/or calcining step, optionally also via the carbohydrates, such as chitin. The production of specially p-doped silicon carbide may also be advantageous, and in this special exception the aluminium content for example can be higher. Doping can be effected using aluminium-containing substances, for example using trimethylaluminium gas.

Depending on the pressure in the reactor, pyrolysis products or compositions with varying degree of agglomeration and varying porosity can be produced in this step. As a rule, the pyrolysis products obtained under vacuum are less agglomerated and have higher porosity than under normal pressure or increased pressure.

The pyrolysis time can be between 1 minute and usually 48 hours, in particular between 15 minutes and 18 hours, preferably between 30 minutes and about 12 hours at the stated pyrolysis temperatures. The phase of heating to the pyrolysis temperature is as a rule included here.

The pressure range is usually 1 mbar to 50 bar, in particular 1 mbar to 10 bar, preferably 1 mbar to 5 bar. Depending on the desired pyrolysis product, and in order to minimize the formation of carbon-containing process gases, in the method the pyrolysis step can also take place in a pressure range from 1 to 50 bar, preferably 2 to 50 bar, especially preferably 5 to 50 bar. A person skilled in the art knows that the pressure to be selected is a compromise between gas removal, agglomeration and reduction of the carbon-containing process gases.

Pyrolysis of the reactants, such as silicon oxide and the carbohydrate, is followed by the calcining step. Calcining (high-temperature region) means a section of the process in which the reactants are substantially converted to high-purity silicon carbide, optionally containing a carbon matrix and/or a silicon oxide matrix and/or mixtures thereof. In this step there is optionally evaporation of water of crystallization and sintering of the method products. As a rule the calcining step (high-temperature step) follows the pyrolysis directly, although it can also be carried out at a later time, for example when the pyrolysis product is sold on. The temperature ranges of the pyrolysis and calcining steps can optionally overlap somewhat. Calcining is usually carried out at 1400 to 2000° C., preferably between 1400 to 1800° C. If pyrolysis takes place at temperatures below 800° C., the calcining step can also extend to a temperature range from 800° C. to about 1800° C. High-purity silicon oxide spheres, in particular quartz glass spheres and/or silicon carbide spheres or generally quartz glass and/or silicon carbide particles can be used in the method, for improved heat transfer. Preferably these heat exchangers are used with rotary kilns or also in microwave furnaces. In microwave furnaces, the microwaves cause excitation in the quartz glass particles and/or silicon carbide particles, so that the particles are heated. Preferably the spheres and/or particles are well distributed in the reaction system, to permit uniform heat transfer.

The calcining or the high-temperature region of the process usually takes place in the pressure range from 1 mbar to 50 bar, in particular between 1 mbar and 1 bar (ambient pressure), in particular at 1 to 250 mbar, preferably at 1 to 10 mbar. The possible inert gas atmospheres are those already mentioned. The calcining time depends on the temperature and the reactants used. As a rule it is between 1 minute and can usually be 48 hours, in particular between 15 minutes and 18 hours, preferably between 30 minutes and about 12 hours at the stated calcining temperatures. The phase of heating to the calcining temperature is as a rule to be included here.

The reaction of silicon oxide and the source of carbon containing a carbohydrate can also take place directly in the high-temperature region, and it must be possible for the resultant gaseous reactants or process gases to be removed properly from the reaction zone. This can be ensured by a loose charge or a charge comprising formed pieces of silicon oxide and/or the source of carbon or preferably with formed pieces comprising silicon dioxide and the source of carbon (carbohydrate). The gaseous reaction products or process gases that form can in particular be steam, carbon monoxide and subsequent products. At high temperatures, in particular in the high-temperature region, there is mainly formation of carbon monoxide.

The reaction to silicon carbide at elevated temperature, in particular in the calcining step, preferably takes place at a temperature from 400 to 3000° C., preferably the calcining takes place in the high-temperature range between 1400 to 3000° C., preferably at 1400° C. to 1800° C., especially preferably between 1450 to 1500 and 1700° C. The temperature ranges are not to be limited to those disclosed, as the temperatures reached are also directly dependent on the reactors used. The stated temperatures are based on measurements with standard high-temperature temperature sensors for example encapsulated (PtRhPt element) or alternatively from the colour temperature by visual comparison with a spiral-wound filament.

All the reactors known by a person skilled in the art for pyrolysis and/or calcining may be considered as reactors for use in the method according to the invention. Therefore all reactors known by a person skilled in the art: laboratory reactors, pilot-plant reactors or preferably large-scale industrial reactors, for example rotating-tube reactor or also a microwave reactor, as used for the sintering of ceramics, can be used for the pyrolysis and subsequent calcining for SiC formation and optionally graphitization.

The microwave reactors can be operated in the high-frequency range (HF range), high-frequency range being understood within the scope of the present invention as 100 MHz to 100 GHz, in particular between 100 MHz and 50 GHz or also 100 MHz to 40 GHz. Preferred frequency ranges are roughly between 1 MHz to 100 GHz, with 10 MHz to 50 GHz being especially preferred. The reactors can be operated in parallel. Especially preferably, magnetrons of 2.4 MHz are used for the method.

The high-temperature reaction can also take place in usual melting furnaces for the production of steel or silicon, such as metallurgical silicon, or other suitable melting furnaces, for example induction furnaces. The design of said melting furnaces, especially preferably electric furnaces, which use an electric arc as the energy source, is sufficiently familiar to a person skilled in the art and is not part of this application. In the case of direct-current furnaces, they have a melting electrode and a bottom electrode or as an alternating-current furnace usually three melting electrodes. Arc length is controlled by an electrode controller. Arc furnaces are as a rule based on a reaction space made of refractory material. The raw materials, in particular the pyrolyzed carbohydrate on silicic acid/SiO₂, are fed at the top, where the graphite electrodes for generating the arc are also arranged. These furnaces are generally operated at temperatures in the region of 1800° C. A person skilled in the art is also aware that the furnace fittings themselves should not contribute to contamination of the silicon carbide produced. Preferably the high-temperature reaction to silicon carbide takes place in a reactor according to the invention and/or with electrodes according to the invention and/or in a device according to the invention.

The invention also relates to a composition comprising silicon carbide optionally with a carbon matrix and/or silicon oxide matrix or a matrix comprising silicon carbide, carbon and/or silicon oxide and optionally silicon, that is obtainable by the method component according to the invention, in particular by the calcining step, and in particular is isolated. Isolation means that after carrying out the method, the composition and/or the high-purity silicon carbide is obtained and isolated, in particular as product. The silicon carbide can moreover be provided with a passivation layer, for example containing SiO₂.

This product can then serve as reactant, catalyst, material for the production of articles, for example filters, formed articles or green articles and can be used in other applications familiar to a person skilled in the art. Another important application is use of the composition comprising silicon carbide as reaction starter and/or reactant and/or in the production of electrode material or in the production of silicon carbide with sugar coke and silicic acid.

The invention also relates to the pyrolysis product and optionally calcining product, in particular a composition obtainable by the method component according to the invention and in particular the pyrolysis and/or calcination product isolated from the method, with a content of carbon to silicon oxide, in particular of silicon dioxide, from 400:0.1 to 0.4:1000.

Preferably the conductivity of the products from the method component, in particular the high-density compressed pulverulent method component products, measured between two pointed electrodes, is in the range κ[m/Ω.m²]=1·10⁻¹ to 1·10⁻⁶. A low conductivity, which is directly correlated with the purity of the method product, is desirable for the respective silicon carbide method component product.

Preferably the composition or the pyrolysis and/or calcination product has a graphite content from 0 to 50 wt. %, preferably 25 to 50 wt. % relative to the total composition. According to the invention the composition or the pyrolysis and/or calcination product has a proportion of silicon carbide from 25 to 100 wt. %, in particular from 30 to 50 wt. %. relative to the total composition.

The invention also relates to a silicon carbide with a carbon matrix comprising coke and/or carbon black and/or graphite or mixtures thereof and/or with a silicon oxide matrix comprising silicon dioxide, silicic acid and/or mixtures thereof or with a mixture of the aforementioned components, obtainable by the method according to the invention, in particular according to one of Claims 1 to 10. In particular the SiC is isolated and used further, as described below.

The overall content of the elements boron, phosphorus, arsenic and/or aluminium is preferably below 10 wt.-ppm in the silicon carbide in accordance with the definition of the invention.

The invention also relates to a silicon carbide optionally with carbon fractions and/or silicon oxide fractions or mixtures, comprising silicon carbide, carbon and/or silicon oxide, in particular silicon dioxide, with a content of the impurities as defined above.

According to one embodiment, the invention relates to the use of silicon carbide or a composition or a pyrolysis and/or calcination product of the method in the production of pure silicon, in particular in the production of solar-grade silicon. The invention relates in particular to the use in the production of solar-grade silicon by reduction of silicon dioxide, in particular of purified silicon oxide, at high temperatures or in the production of silicon carbide by reacting coke, in particular from sugar coke, and silicon dioxide, in particular a silicic acid, preferably a silicic acid or SiO₂—pyrogenic, precipitated or purified by ion exchange—at high temperatures, as grinding material, insulator, as refractory, such as heat-resistant tile, or in the production of articles or in the production of electrodes.

The invention also relates to the use of silicon carbide or a composition or a pyrolysis and/or calcination product obtainable by the method according to the invention as catalyst, in particular in the production of silicon, preferably in the production of purified silicon, in particular in the production of solar-grade silicon, in particular in the production of solar-grade silicon by reduction of silicon dioxide at high temperatures. And optionally in the production of silicon carbide for semiconductor uses or for use as catalyst in the production of ultrapure silicon carbide, for example by sublimation, or as reactant in the production of silicon or in the production of silicon carbide, in particular from coke, preferably from sugar coke, and silicon dioxide, preferably with silicic acid, at high temperatures, or for use as material of articles or as electrode material, in particular for arc furnace electrodes. The use as material of articles, in particular electrodes, comprises the use of the material as material for the articles or also the use of further processed material for the production of the articles, for example of sintered material or of grinding materials.

Another object of the invention is the use of at least one carbohydrate, in particular a pure carbohydrate, in the production of pure to ultrapure silicon carbide, in particular silicon carbide that can be isolated as product, or a composition containing silicon carbide or a pyrolysis and/or calcination product containing silicon carbide, in particular in the presence of silicon oxide, preferably in the presence of silicon oxide and/or silicon dioxide.

Preferably a selection from at least one carbohydrate and a silicon oxide, in particular a purified silicon dioxide, in particular without further components, is used for the production of silicon carbide, and the silicon carbide, a composition containing silicon carbide or a pyrolysis and/or calcination product is isolated as reaction product.

The invention also relates to the use of a composition, in particular formulation, or a kit comprising at least one carbohydrate and silicon oxide, in particular of purified silicon oxide, in the method according to the invention. Therefore the invention also relates to a kit, containing separated formulations, in particular in separate containers, such as vessels, bags and/or cans, in particular in the form of an extrudate and/or powder of silicon oxide, in particular of purified silicon oxide, preferably of purified silicon dioxide, optionally together with pyrolysis products of carbohydrates on SiO₂ and/or the source of carbon comprising at least one carbohydrate, in particular for use in accordance with the foregoing. It may be preferable if the silicon oxide directly with the source of carbon comprising a carbohydrate, in particular a source of pure carbon, for example impregnated therewith or the carbohydrate supported on SiO₂ etc. in the form of tablets, as granules, extrudate, briquette, in particular as pellet or briquette, is in a container in the kit and optionally an additional carbohydrate and/or silicon oxide as powder in a second container.

The invention further relates to the use of an article, in particular of a green product, formed material, sintered part, of an electrode, of a heat-resistant component, comprising a silicon carbide according to the invention or a composition according to the invention containing silicon carbide, and optionally further usual additives, processing aids, pigments or binders in the complete method according to the invention. The invention therefore relates to an article containing a silicon carbide according to the invention, or that is produced using the silicon carbide according to the invention and its use in the complete method according to the invention.

Use of SiC as Activator in the Reduction of the Silicon Dioxide with the Source of Carbon

As explained at the beginning, silicon carbide can also be added in the complete method according to the invention for the production of pure silicon.

According to the invention, the economic effectiveness of the method for the production of pure silicon is increased considerably by adding an activator, which performs the function of a reaction starter, reaction accelerator and/or as a source of carbon. At the same time the activator, i.e. reaction starter and/or reaction accelerator, should be as pure and inexpensive as possible. Especially preferred reaction starters and/or reaction accelerators should not themselves introduce any unwanted impurities or preferably only impurities in the minutest amounts into the silicon melt, for the reasons stated at the beginning.

The method according to the invention can be carried out in various ways, and according to an especially preferred embodiment a silicon oxide, in particular silicon dioxide, preferably a silicon dioxide purified by acid precipitation, is reacted at elevated temperature, by adding silicon carbide to the process as a source of pure carbon or as activator to the silicon oxide, according to the invention to the silicon oxide purified by precipitation, or silicon carbide (SiC) in a composition containing silicon oxide, it being especially preferable if the silicon oxide, in particular the silicon dioxide, and the silicon carbide are added in approximately stoichiometric proportions, i.e. about 1 mol SiO₂ to 2 mol SiC for the production of silicon, in particular the reaction mixture for the production of silicon consists of silicon oxide and silicon carbide.

Another advantage of this way of carrying out the method is that by adding SiC correspondingly less CO is released per Si formed. Gas pollution, which limits the process decisively, is thus advantageously reduced. Thus, process intensification is advantageously possible by adding SiC.

According to another especially preferred embodiment, the silicon oxide purified by precipitation, in particular silicon dioxide, is reacted at elevated temperature, where silicon carbide and another source of pure carbon is added to the silicon oxide or silicon carbide and a source of pure carbon, in particular a second source of pure carbon, in a composition containing silicon oxide, or is reacted. In this variant the concentration of silicon carbide can be lowered to such an extent that it functions more as reaction starter and/or reaction accelerator and less as a reactant. Preferably, about 1 mol silicon dioxide can also be reacted with about 1 mol silicon carbide and about 1 mol of a second source of carbon in the method.

According to the invention, in the method for the production of silicon by reacting purified silicon oxide at elevated temperature the silicon carbide is added to the silicon oxide or optionally is added in a composition containing the purified silicon oxide, in particular an electric arc is used as energy source. The purpose is for a silicon carbide to be added as activator i.e. as reaction starter and/or reaction accelerator and/or as source of carbon, i.e. as reactant, to the method and/or to be added in a composition to the method.

The silicon carbide is thus fed to the method separately. Preferably silicon carbide is added as reaction starter and/or reaction accelerator to the method or to the composition. As silicon carbide itself does not decompose until temperatures of about 2700 to 3070° C. are reached, it was surprising that it can be added to the method for the production of silicon as reaction starter and/or reaction accelerator or as reactant or also as heat-exchange medium. Entirely surprisingly, it was observed in an experiment that after striking an electric arc, the reaction between silicon dioxide and carbon, in particular graphite, which starts and proceeds very slowly, on adding small amounts of pulverulent silicon carbide led within a short time to a very marked increase in reaction. Luminous effects were observed, and surprisingly the entire subsequent reaction took place with an intensive, bright glow, in particular up to the end of the reaction.

A “further or second source of pure carbon”, in particular additional to the silicon carbide, was defined, in the context of the method for the production of silicon, as compounds or materials that do not consist of silicon carbide, do not have any silicon carbide or do not contain any silicon carbide. Therefore the second source of carbon does not consist of silicon carbide, does not have any silicon carbide or does not contain any silicon carbide. The function of the second source of carbon is rather that of a pure reactant, whereas the silicon carbide is also a reaction starter and/or reaction accelerator. As the second source of carbon, consideration may be given in particular to sugars, graphite, coal, charcoal, carbon black, coke, anthracite, lignite, activated carbon, petroleum coke, wood as wood chip or pellets, rice husks or stalks, carbon fibre, fullerenes and/or hydrocarbons, in particular gaseous or liquid, and mixtures of at least two of the stated compounds, provided they are of suitable purity and do not contaminate the method with undesirable compounds or elements. The second source of carbon is preferably selected from the stated compounds. The contamination of the further or second source of pure carbon with boron and/or phosphorus or boron-containing and/or phosphorus-containing compounds should be for boron below 10 ppm, in particular between 10 ppm and 0.001 ppt, and for phosphorus below 20 ppm, in particular between 20 ppm and 0.001 ppt, in proportions by weight. Amounts given in ppm, ppb and/or ppt are to be understood throughout as proportions by weight in mg/kg, μg/kg etc.

The boron content is preferably between 7 ppm and 1 ppt, preferably between 6 ppm and 1 ppt, especially preferably between 5 ppm and 1 ppt or lower, for example between 0.001 ppm and 0.001 ppt, preferably in the region of the limit of analytical detection. The phosphorus content should preferably be between 18 ppm and 1 ppt, preferably between 15 ppm and 1 ppt, especially preferably between 10 ppm and 1 ppt or lower. The phosphorus content is preferably in the region of the limit of analytical detection. Generally this limit values are desirable for all reactants or additives of the method, to be suitable for the production of solar-grade and/or semiconductor-grade silicon.

A purified or high-purity silicon oxide defined above, in particular a purified or high-purity silicon dioxide, is preferably used as silicon oxide.

In addition to the silicon oxide purified by precipitation, other correspondingly pure silicon oxides can be used in the method for the production of pure silicon.

The addition of other suitable silicon oxides additionally to the purified silicon oxide may also be advantageous, namely quartz, quartzite and/or silicon dioxides produced in the usual way. These can be the silicon dioxides occurring in crystalline modifications, such as morganite (chalcedony), α-quartz (low quartz), β-quartz (high quartz), tridymite, cristobalite, coesite, stishovite or also amorphous SiO₂. Moreover, silicic acids, pyrogenic SiO₂, pyrogenic silicic acid or silica can preferably be used in the method and/or the composition. Usual pyrogenic silicic acids are amorphous SiO₂ powders averaging 5 to 50 nm in diameter and with a specific surface of 50 to 600 m²/g. The above list is not to be understood as final, it is obvious to a person skilled in the art that other silicon oxide sources suitable for the method can be used in the method and/or the composition.

Purified silicon oxide, in particular purified silicon dioxide, and silicon carbide and optionally a second source of carbon, in particular a second source of pure carbon, are preferably used in the method in the following stated molar proportions and/or wt. %, where the figures can relate to the educts and in particular to the reaction mixture in the method:

Per 1 mol of a silicon oxide, for example silicon monoxide, such as Patinal®, about 1 mol of a second source of pure carbon and silicon carbide in small amounts can be added as reaction starters or reaction accelerators. Usual amounts of silicon carbide as reaction starter and/or reaction accelerator are about 0.0001 wt. % to 25 wt. %,
preferably 0.0001 to 20 wt. %, especially preferably 0.0001 to 15 wt. %, in particular 1 to 10 wt. % relative to the total weight of the reaction mixture, in particular comprising silicon oxide, silicon carbide and a second source of carbon and optionally further additives.

It may also be especially preferable to add to the method, per 1 mol of a purified silicon oxide, in particular silicon dioxide, about 1 mol of pure silicon carbide and about 1 mol of a second source of carbon, in particular of pure carbon. If a silicon carbide containing carbon fibres or similar compounds containing additional carbon is used, the amount of a second source of carbon in mol can be lowered correspondingly. Per 1 mol of silicon dioxide, about 2 mol of a second source of carbon and silicon carbide in small amounts can be added as reaction starter or reaction accelerator. Usual amounts of silicon carbide as reaction starter and/or reaction accelerator are about 0.0001 wt. % to 25 wt. %, preferably 0.0001 to 20 wt. %, especially preferably 0.0001 to 15 wt. %, in particular 1 to 10 wt. % relative to the total weight of the reaction mixture, in particular comprising silicon oxide, silicon carbide and a second source of carbon and optionally further additives.

According to a preferred alternative, per 1 mol of silicon dioxide, about 2 mol of silicon carbide can be used as reactant in the method and optionally a second source of carbon can be present in small amounts. Usual amounts of the second source of carbon are about 0.0001 wt. % to 29 wt. %, preferably 0.001 to 25 wt. %, especially preferably 0.01 to 20 wt. %, quite especially preferably 0.1 to 15 wt. %, in particular 1 to 10 wt. % relative to the total weight of the reaction mixture, in particular comprising silicon dioxide, silicon carbide and a second source of carbon and optionally further additives.

Stoichiometrically, in particular silicon dioxide can be reacted with silicon carbide and/or a second source of carbon according to the following reaction equations:

SiO₂+2C→Si+2CO

SiO₂+2SiC→3Si+2CO

or

SiO₂+SiC+C→2Si+2CO or

SiO₂+0.5SiC+1.5C→1.5Si+2CO or

SiO₂+1.5SiC+0.5C→2.5Si+2CO etc.

Because the purified silicon dioxide can react in the molar ratio of 1 mol with 2 mol of silicon carbide and/or of the second source of carbon, there is the possibility of controlling the method by means of the molar ratio of silicon carbide and the further or second source of pure carbon. Preferably silicon carbide and the second source of carbon together should be used in the method or be present in the method roughly in the ratio of 2 mol to 1 mol of silicon dioxide. Thus, the 2 mol of silicon carbide and optionally the second source of carbon can be composed of 2 mol SiC to 0 mol of the second source of carbon up to 0.00001 mol SiC to 1.99999 of the second source of carbon (C). The ratio of silicon carbide to the second source of carbon preferably varies within the stoichiometric about 2 mol for reaction with about 1 mol silicon dioxide in accordance with Table 1:

TABLE 1

| | | | Second |
|---|---|---|---|
| | Silicon dioxide | Silicon carbide (SiC) | source of carbon (C) |
| Reaction: | in mol | in mol | in mol |
| No. 1 | 1 | 2 | 0 |
| No. 2 | 1 | 1.99999 | 0.00001 |
| | | to | to |
| No. ∞ | 1 | 0.00001 | 1.9999 |

where SiC + C
together always
come to about 2 mol.

For example, the 2 mol of SiC and optionally C together are composed of 2 to 0.00001 mol SiC and 0 to 1.99999 mol C, in particular from 0.0001 to 0.5 mol SiC and 1.9999 to 1.5 C to 2 mol, preferably 0.001 to 1 mol SiC and 1.999 to 1 C to 2 mol, especially preferably 0.01 to 1.5 mol SiC and 1.99 to 0.5 C to 2 mol, in particular it is preferable in the method according to the invention to use 0.1 to 1.9 mol SiC and 1.9 to 0.1 C to 2 mol per approx. 1 mol silicon dioxide.

As silicon carbides for use in the method according to the invention or the composition according to the invention, consideration may be given to preferably pure to ultrapure silicon carbides in accordance with the above definition, and generally all polytypic phases, and optionally the silicon carbide can be coated with a passivating layer of SiO₂. Individual polytypic phases with varying stability can preferably be used in the method, because for example the course of the reaction or the start of reaction in the method can be controlled with them. High-purity silicon carbide is colourless and is preferably used in the method. Moreover, as silicon carbide in the method or in the composition, it is possible to use commercial SiC (carborundum), metallurgical SiC, SiC-binding matrices, open-pore or dense silicon carbide ceramics, such as silicate-bound silicon carbide, recrystallized SiC (RSiC), reaction-bound, silicon-infiltrated silicon carbide (SiSiC), sintered silicon carbide, hot (isostatically) compressed silicon carbide (HpSiC, HiPSiC) and/or liquid-phase-sintered silicon carbide (LPSSiC), carbon fibre-reinforced silicon carbide composites (CMC, ceramic matrix composites) and/or mixtures of these compounds, with the proviso that the contamination is so slight that the silicon produced is suitable for the production of solar-grade silicon and/or semiconductor-grade silicon. The aforementioned silicon carbides can also be added to the method in small amounts provided that the total contamination of the pure silicon corresponds to that according to the invention. Therefore silicon carbides can also be recycled in certain amounts in the method according to the invention provided that the total contamination of the pure silicon produced is achieved. A person skilled in the art is aware that the overall contamination of the pure silicon obtained can be controlled by adding different charges and with varying impurity profiles.

The contamination of the silicon carbide suitable for the method with boron and/or phosphorus or with boron-containing and/or phosphorus-containing compounds is preferably for boron below 10 ppm, in particular between 10 ppm and 0.001 ppt, and for phosphorus below 20 ppm, in particular between 20 ppm and 0.001 ppt. Preferably the boron content in a silicon carbide is between 7 ppm and 1 ppt, preferably between 6 ppm and 1 ppt, especially preferably between 5 ppm and 1 ppt or lower, or for example between 0.001 ppm and 0.001 ppt, preferably in the region of the limit of analytical detection. The phosphorus content of a silicon carbide should preferably be between 18 ppm and 1 ppt, preferably between 15 ppm and 1 ppt, especially preferably between 10 ppm and 1 ppt or lower. The phosphorus content is preferably in the region of the limit of analytical detection.

As silicon carbides are being used increasingly as composite for example for the production of semiconductors, brake disk material or heat shields and other products, the method according to the invention and the composition or formulation offer a possibility for elegant recycling of these products after use or of the waste or scrap arising in their production. The only requirement to be met by the silicon carbides that are to be recycled is sufficient purity for the method, and preferably silicon carbides that satisfy the above specification with respect to boron and/or phosphorus are recycled. The silicon carbide can be added to the method a) as pulverulent or granular material and/or as lumps and/or b) contained in a porous glass, in particular quartz glass, in an extrudate and/or moulding, such as pellet or briquette, in particular in a formulation described above, optionally together with other additives.

All reactants, i.e. the purified silicon oxide, silicon carbide and optionally additional sources of pure carbon, each separately or in compositions or formulations, can be added to the method continuously or discontinuously. Preferably the silicon carbide is added in the amounts and in the course of the method to an extent such that an especially economical execution of the method is achieved. Therefore it may be of advantage if the silicon carbide is added stepwise continuously, in order to maintain a continuous reaction acceleration of the reaction.

The reaction can be carried out in usual melting furnaces for the production of silicon, carried out as described at the beginning. Preferably the method is carried out in a device according to the invention, reactor and with electrodes according to the invention.

As mentioned above, depending on the impurity profile of the other reactants the silicon carbide can be used as silicon carbide, as pure silicon carbide or as ultrapure silicon carbide or also as a mixture of these. In mixtures, the silicon carbides are preferably formulated beforehand, in particular briquetted. The general rule is: the more contaminated the silicon carbide, the smaller its amount in the method.

The method can be carried out so that
a) the silicon carbide and purified silicon oxide, in particular silicon dioxide, and optionally another source of pure carbon are each fed separately to the method, in particular the reaction space, and optionally are then mixed together and/or
b) the silicon carbide together with purified silicon oxide, in particular silicon dioxide, and optionally another source of pure carbon in a formulation and/or
c) the purified silicon oxide, in particular silicon dioxide, together with a source of pure carbon in a formulation, in particular in the form an extrudate or moulding, preferably as pellet or briquette, and/or
d) the silicon carbide in a composition with the additional source of pure carbon, is added or fed to the method. This formulation can comprise a physical mixture, an extrudate or moulding or also a carbon fibre-reinforced silicon carbide.

As already mentioned for the silicon carbide, the silicon carbide and/or silicon oxide and optionally at least one additional source of pure carbon can be fed to the method as material to be recycled. The only requirement imposed on all compounds to be recycled is that they are of sufficient purity for forming a silicon in the method, from which solar-grade silicon and/or semiconductor-grade silicon can be produced.

Similarly, in the method according to the invention, in addition to purified silicon oxide it is also possible to use silicon oxides of sufficient purity that are to be recycled. Quartz glasses are suitable, for example cullet. To take just a few, these can be Suprasil, SQ 1, Herasil, Spektrosil A. The purity of these quartz glasses can be determined for example from the absorption rates at specified wavelengths, such as 157 nm or 193 nm. For example, almost consumed electrodes, which have been reduced to a desired form, for example as powder, can be used as the second source of carbon.

The pure silicon produced or obtained with the method according to the invention is, according to the invention, optionally after zone melting/directional solidification, suitable as solar-grade silicon. Preferably it is suitable a) for further processing in processes for the production of solar-grade silicon or semiconductor-grade silicon.

The contamination of the silicon produced with boron-containing and/or phosphorus-containing compounds should correspond to the spectrum defined at the start of this description, but it can also be, for boron in the range from below 10 ppm to 0.0001 ppt, in particular in the range from 5 ppm to 0.0001 ppt, preferably in the range from 3 ppm to 0.0001 ppt or especially preferably in the range from 10 ppb to 0.0001 ppt, even more preferably in the range from 1 ppb to 0.0001 ppt and for phosphorus in the range from below 10 ppm to 0.0001 ppt, in particular in the range from 5 ppm to 0.0001 ppt, preferably in the range from 3 ppm to 0.0001 ppt or especially preferably in the range from 10 ppb to 0.0001 ppt, even more preferably in the range from 1 ppb to 0.0001 ppt, stated in proportions by weight. The range of impurities generally has no lower limit, but is determined solely by the actual limits of detection of the analytical techniques. According to the invention, pure silicon has the profile of contamination with boron, aluminium, calcium, iron, nickel, phosphorus, titanium and/or zinc stated at the beginning.

Advantageously, the molten silicon can undergo treatment with rare-earth metals, in order to remove carbon, oxygen, nitrogen, boron or any other impurities that are present, from the molten silicon.

The invention also relates to a composition that is especially suitable for use in the aforementioned method for the production of silicon and whose quality is preferably suitable as solar-grade silicon or for the production of solar-grade silicon and/or semiconductor-grade silicon, with the composition containing silicon oxide and silicon carbide and optionally a second source of carbon, in particular a source of pure carbon. Those stated above may be considered as purified silicon oxide, in particular silicon dioxide, silicon carbide and optionally the second source of carbon, and preferably they also meet the purity requirements stated there.

The silicon carbide can also be present, optionally together with other additives, in the formulation, as described above a) as powder, as granules and/or as lumps and/or b) contained in a porous glass, in particular quartz glass, in an extrudate and/or pellet. In further embodiments, the formulation can contain silicon-infiltrated silicon carbide and/or silicon carbide containing carbon fibres. These formulations are to be preferred if corresponding silicon carbides are to be recycled, because they can no longer be used in some other way, for example production scrap or used products. Provided the purity is sufficient for the method according to the invention, in this way it is possible for silicon carbides, silicon carbide ceramics, such as hot plates, brake disk material, to be recycled again. As a rule, because of the production process, these products already have sufficient purity. The invention can therefore also relate to the recycling of silicon carbides in a method for the production of silicon. The binders defined above, in particular the heat-resistant or refractory binders, can be used as binders for production of the formulation.

The invention also relates to the use of the silicon produced by the method according to the invention as base material for solar cells and/or semiconductors or in particular as starting material for the production of solar-grade silicon.

### Reactors Suitable for Use in the Complete Method According to the Invention

The invention also relates to a reactor, a device and electrodes, suitable in particular for the production of solar-grade silicon or semiconductor-grade silicon.

In order to be able to produce silicon of high purity it is necessary to develop reduction furnaces, with which contamination with impurities can be avoided to the greatest possible extent. As a rule reactors are at present lined with refractories, such as graphite and/or silicon carbide. The electrodes of the reduction furnaces are also made of graphite. Graphite has the necessary conductivity and heat resistance. An important drawback of the materials is at present insufficient purity. Refractories are usually contaminated with boron, phosphorus, aluminium, and iron.

According to one embodiment, the invention therefore relates to a reactor that is suitable in particular for use with induction, direct-current and/or alternating-current furnaces, preferably it is suitable for the production of silicon, according to the invention for the production of pure silicon, where the reactor can correspond to reactor 1 and/or 2 described below. The reactor according to the invention is characterized in that it has silicon carbide electrodes or silicon-infiltrated silicon carbide electrodes. The silicon-infiltrated silicon carbide of the electrodes has the advantage that it . . . in particular by the reaction of SiO₂, preferably of purified silicon dioxide, and the pyrolysis and/or calcining of at least one carbohydrate-containing source of carbon, preferably a source of pure carbon, in particular of the following purity:

The content of boron, phosphorus, arsenic, aluminium, iron, sodium, potassium, nickel, and chromium is, for pure silicon carbide, for each element preferably below 5 ppm to 0.01 ppt (by weight), and for high-purity silicon carbide in particular below 2.5 ppm to 0.1 ppt. Especially preferably, the silicon carbide obtained after reaction of a silicon oxide and a source of pure carbohydrate, in particular purified sugar, optionally with carbon and/or Si_{y}O_{z} matrices, has a purification profile for SiC as defined at the start of the description.

An especially preferred pure to high-purity silicon carbide or a high-purity composition contains or consists of silicon carbide, carbon, silicon oxide and optionally small amounts of silicon, and the high-purity silicon carbide or the high-purity composition in particular has a profile of contamination with boron, phosphorus, arsenic, aluminium, iron, sodium, potassium, nickel, chromium, sulphur, barium, zirconium, zinc, titanium, calcium, magnesium, copper, chromium, cobalt, zinc, vanadium, manganese and/or lead of below 100 ppm for pure silicon carbide, preferably of below 20 ppm to 0.001 ppt for high-purity silicon carbide, especially preferably between 10 ppm and 0.001 ppt relative to the high-purity complete composition or the high-purity silicon carbide.

Especially preferably the silicon carbide is obtained from the reaction of a purified silicon oxide and a pure carbohydrate source, in particular purified sugar as described above. During the reaction the silicon content can be controlled by the reaction conditions or also by adding separate silicon. Preferably the silicon carbide is produced by the method presented above for the production of silicon carbide.

The attainable purity of the silicon carbide or of the silicon-infiltrated silicon carbide as electrode material corresponds to the purities presented above. Preferably the silicon carbide is pure to ultrapure. For improvement of mechanical stability, the silicon-infiltrated silicon carbide electrodes or the silicon carbide electrodes can be reinforced with carbon fibres. According to the invention, the reactor for carrying out the method according to the invention is used for the production of pure silicon.

A pure to high-purity silicon carbide or silicon-infiltrated silicon carbide, optionally containing carbon, in particular as electrode material or for lining a reactor or a device, is characterized in that its content of impurities corresponds to the ranges for SiC defined at the start of this description, in particular the total of the aforementioned impurities is less than 5 ppm, preferably less than 4 ppm, especially preferably less than 3 ppm, quite especially preferably between 0.5 and 3 ppm and especially preferably between 1 ppm and 0.001 ppt. A silicon carbide with preferred ranges at the limit values is regarded as high-purity.

Corresponding limit values for aluminium, boron, calcium, iron, nickel, phosphorus, titanium, and zinc apply to a high-purity graphite. These are in particular:
Boron below 5.5 [μg/g], in particular between 5 and 0.000001 μg/g, preferably 3 and 0.00001 μg/g, especially preferably 2 and 0.00001 μg/g, according to the invention below 2 to 0.00001 μg/g,
Phosphorus below 5.5 [μg/g], 5 to 0.000001 μg/g, preferably 3 to 0.00001 μg/g, especially preferably below 1 to 0.00001 μg/g, according to the invention below 0.5 to 0.00001 μg/g.
Aluminium between 4 and 0.000001 μg/g, preferably 3 to 0.00001 μg/g, especially preferably below 2.5 to 0.00001 μg/g, according to the invention below 2 to 0.00001 μg/g.
Iron between 100 and 0.000001 μg/g, preferably between 60 and 0.00001 μg/g, in particular between 10 and 0.000001 μg/g, preferably 5 to 0.00001 μg/g, especially preferably 2 to 0.00001 μg/g, quite especially preferably below 1 to 0.00001 μg/g, according to the invention below 0.5 to 0.00001 μg/g.
Sodium (Na) between 20 and 0.000001 μg/g, preferably 15 to 0.00001 μg/g, especially preferably below 12 to 0.00001 μg/g, according to the invention below 10 to 0.00001 μg/g,
Potassium (K) between 30 and 0.000001 μg/g, preferably 25 to 0.00001 μg/g, especially preferably below 20 to 0.00001 μg/g, according to the invention below 16 to 0.00001 μg/g,
Nickel (Ni) between 4 and 0.000001 μg/g, preferably 3 to 0.00001 μg/g, especially preferably below 2 to 0.00001 μg/g, according to the invention below 1.5 to 0.00001 μg/g,
Chromium (Cr) between 4 and 0.000001 μg/g, preferably 3 to 0.00001 μg/g, especially preferably below 2 to 0.00001 μg/g, according to the invention below 1 to 0.00001 μg/g.

Minimal contamination with the respective elements is preferred, especially preferably below 100 ppm, quite especially preferably below 10 ppb or below 1 ppb.

Another disadvantage of reactors currently in use is the multiple lining with ordinary refractory bricks, from which impurities can be introduced into the hot silicon melt. Even if the refractory bricks are not in direct contact with the melt.

The invention also relates to a reactor (0), in particular for use with industrial furnaces, for example microwave, induction, direct-current and/or alternating-current furnaces, preferably for the production of silicon or pure metals and/or alloys, in particular pure silicon, where said reactor (0) can also correspond to a reactor 1 and/or 2 defined below, with at least the reaction space (1) of the reactor (0) or of the reactors (0) for melting and optionally for reduction, in particular of silicon oxide with at least one or more sources of carbon, having a metal tap-hole and optionally a slag hole
has a sandwich construction with at least two layers, in particular the sandwich construction is made up of a first inner layer (7), another outer layer (6) and optionally an outermost layer (8),
   the reaction space (1) or the reactor (0) being lined internally with a first layer (6) of high-purity refractory material, in particular with pure to high-purity silicon carbide or high-purity graphite,
   has an outermost layer (7), which functions as an insulating and/or diffusion barrier against impurities, in particular at high temperatures, and
   optionally has, on the outside, a mechanically stable outermost layer (8).

According to the invention, the reactor is used for carrying out the method according to the invention for the production of pure silicon. Preferably the reactor can be used for reduction and/or melting of metallic compounds or mixtures thereof optionally in the presence of reducing agents or the like to metals or alloys, the reactor according to the invention being especially suitable for reduction and/or melting of pure to high-purity metals, metalloids or alloys or mixtures thereof.

A first layer (7) of high-purity refractory material is to be understood as any material that is suitable for use at high temperatures and has the defined impurity profile. This first layer comes into direct contact with the silicon melt or the hot reactants. A high-purity graphite or high-purity silicon carbide preferably has an impurity profile preferably has the aforementioned impurity profile, as defined above. All ancillary components and connecting points or connecting parts of the reactor to the complete installation (device) can have this first layer (7) of high-purity refractory material. The first layer is preferably segmented, to allow partial replaceability of burnt or spent segments, for example of the high-purity graphite covering. Without segmentation, the entire first layer would have to be replaced if a local area was damaged or consumed by the process. The segmentation can be connectable by the groove/spring principle.

The sandwich construction has the advantage according to the invention that at high temperatures mobile contaminants, for example boron, from more remote parts of the installation can no longer diffuse to the extent as at present through the hot graphite or silicon carbide inner lining at high temperatures into the reaction space and thus enter the melt.

In the sandwich construction, the outermost layer (6) acts as an insulating and/or diffusion barrier against impurities, in particular it prevents diffusion of boron at the high reactor temperatures from outside into the high-purity refractory first layer, for example of graphite, and thus into the silicon melt. The optional stable mechanical outer layer (8) can be made of usual heat-resistant materials, which owing to the diffusion barrier according to the invention are not subject to increased requirements with respect to purity.

The outermost layer (6) with the function of an insulating and/or diffusion barrier can be a vacuum or a hollow part with vacuum, for example a hollow part made of high-purity glass, in particular quartz glass, which is preferably silvered and has a vacuum inside. According to the invention the hollow part has a vacuum and is provided with an infrared mirror on the side toward the reactor space, preferably coated therewith. The vacuum can also be produced chemically, in particular as so-called super-insulation, whereas the hollow part, which corresponds to the outer layer (6), is silvered on the side toward the reaction space, preferably with an infrared-reflecting material.

Alternatively the first layer and the outer layer can also be joined together tightly, to stop gas entering or escaping, in particular so as to be able to produce a vacuum in a cavity formed between them. As an alternative to a vacuum, it is also possible to use a heat-resistant porous, optionally foam-like material as the outermost layer for insulation. Preferably, for this for example the first layer is provided, in particular coated, with high-purity glass or a high-purity ceramic, possibly followed by, as outermost layer, a porous foamed glass, glass spheres or simply thin high-purity spacers, preferably expanded spheres. In an especially preferred embodiment, this layer is followed by an outer layer, which is joined to the first layer in such a way that the middle layer (outermost layer with for example expanded glass) can additionally have a vacuum applied.

The sandwich construction according to the invention can minimize the thermally induced diffusion of impurities from external parts of the installation into the reaction space.

Owing to consumption of the refractory inner lining of the reactor or reaction space, it is preferable to adapt the reactor size so that it can be operated at power between 600 kW and below 1 MW. According to the invention, industrial reactors, in particular in a production line of a device according to the invention, preferably industrial reactors of arc furnaces, in each case have 100 kW to 1 MW, preferably between 600 kW and below 1 MW, especially preferably between 700 kW and 950 kW, especially preferably between 800 and 900 kW, in particular these furnaces are closed. To ensure correspondingly desired high throughputs of silicon, in particular solar-grade silicon, several reactors can be operated in parallel.

Generally the reactors can also be operated in parallel if they are for example arranged in a process line and are supplied with reactants continuously or discontinuously via a preceding reactor for the production of silicon carbide or for pyrolysis of carbohydrates. Correspondingly, feed with purified silicon oxide can take place in the process line directly or indirectly via the silicon carbide or pyrolysis products.

The invention also relates to electrodes, for example (10), in particular for use with induction, direct-current and/or alternating-current furnaces, in particular for the production of silicon, preferably of pure silicon, said electrodes containing silicon-infiltrated silicon carbide or silicon carbide. In order to improve the mechanical properties, the silicon carbide is preferably reinforced with carbon fibres. In addition, the silicon carbide can have graphite components. The precise adjustment of the composition of silicon carbide to silicon and/or graphite and/or carbon fibres depends in the individual case on the respective desired process conditions, the desired conductivity and the heat resistance. Electrodes of silicon-infiltrated silicon carbide optionally reinforced with graphite fibres or carbon fibres are used according to the invention.

In their design, the electrodes can correspond to the usual designs, to permit continuous pushing of the electrodes, which are consumed during reduction. For this, as a rule the electrodes are made up from individual segments, in particular disks, usually made as round disks, which join together but can be separated. Generally the segments can be of any reasonable shape and preferably can be joined together. Usually, for example disk-shaped electrodes have, on one flat side, one or more projections, which can project into corresponding “negative” recesses on the opposite flat side of the disks. Preferably the projections and the recesses can join together positively.

The disks or other shapes can be produced by production of usual green compacts and sintering thereof. The production of green compacts and sintering additives is well known by a person skilled in the art. It is decisive that in this case the purity of the electrodes is not reduced by sintering additives. It is therefore necessary to ensure that the sintering additives only contain unwanted elements within the stated limits or permit the limit values to be observed in the electrodes produced.

For use, the segmented electrodes, in particular disk-shaped electrodes, can be inserted in a hollow part, with which they are connected together in such a way that the electrodes comprising the superposed disks have permanent conductivity and stability. For example, a large number of disks in the hollow part can be in direct contact with one another and joined firmly to the hollow part by tempering, to form an electrode. As an alternative to recesses, the electrode segments can be screwed together or can be joined together with plug-and-socket connections or by welding. The connectability of said segmented electrodes is familiar as such to a person skilled in the art, and attention must be paid to the purity of the connections used.

According to an alternative embodiment, the segmented electrodes are pushed into hollow parts made of silicon, for example pure silicon tubes, and in particular joined together positively, for example by means of a plug-and-socket connector or by spot welding. This construction permits easy pushing or repositioning of spent electrodes in the arc furnace, wherein segments of the electrode made of silicon carbide or silicon-infiltrated silicon carbide, in particular with graphite and/or carbon fibres or with C matrices, can be pushed continuously from above or outside of the furnace into the hollow part made of silicon. The hollow part can generally be of any suitable material, with the use of silicon being preferred for the production of silicon, in particular of pure or high-purity silicon. In processes for the production of steels, the hollow part can also be made from other suitable metals or alloys of said metals, for example an iron tube can receive the high-purity graphite electrodes or silicon carbide electrodes.

The purity requirements correspond essentially to those mentioned previously. In particular an electrode comprising silicon carbide should comprise high-purity silicon carbide and/or high-purity graphite and/or mixtures thereof, in particular it is also possible to use high-purity silicon-infiltrated silicon carbide, preferably the electrodes consist of one or more of the high-purity materials or a corresponding mixture, and the connectors can be made of other materials.

The invention also relates to a device, in particular an installation, preferably for the production of silicon, especially preferably for the production of pure silicon, in particular by the method according to the invention, said device having at least one reactor 1 for melting and optionally for reduction, in particular of silicon oxide with at least one or more sources of carbon, with a metal tap-hole and optionally a slag hole, in particular a reactor of sandwich construction according to Claim 14 and in particular with silicon carbide or silicon-infiltrated silicon carbide electrodes according to Claim 15, and optionally has at least one reactor 2 upstream of reactor 1, said reactor 2 serving for calcining and/or reduction, in particular of silicon oxide with at least one or more sources of carbon. Reactor 2 can in particular be a microwave reactor optionally with a rotating-tube reactor space or a fluidized bed.

The device is generally suitable as an industrial furnace, in particular is also suitable for the reduction and/or melting of metallic compounds or mixtures of said metallic compounds, in particular it is suitable for the production of pure to high-purity metals, alloys and/or mixtures thereof.

According to the invention, each reactor 1 for the production of silicon has a power from 600 kW to 1 MW, preferably the reactor has a power from 670 kW to 990 kW, better still a power from 700 kW to 950 kW, according to the invention from 700 kW to 950 kW.

Reactor 2 can in contrast be of larger design. A microwave reactor can preferably be used, as explained at the beginning, in particular it operates in the high-frequency range between 100 MHz and 100 GHz. Especially preferably, magnetrons of 2.4 MHz are used for reactor 2.

It has proved advantageous to design the reactors 1 with the stated smaller power ratings, in order to simplify the regularly required reconditioning of the reactors or of the lining. Usually the aim is to provide ever larger reactors with ever larger throughput. The inventors found, however, that design of the reactors with a power rating as mentioned above is more suitable for the production of high-purity compounds obtained by melting, for example silicon, because the reactors, and in particular the reactor lining must be replaced regularly, as it is consumed in the course of continuous operation. Moreover, the reactors are to be operated in substantially oxygen-free conditions, to minimize burn-off of graphite of the electrodes and of the inner lining, in particular of a segmented inner lining.

According to the invention, a device is therefore operated with at least one in particular with a large number of reactors, for example with 1 to 200, in particular reactors 1. A reactor lining can therefore be renewed regularly, without having to shut down the whole device when a few reactors are relined with refractory material.

Furthermore, it is easier to lead away the process gases in the smaller reactors. For rapid reduction, the carbon monoxide that forms must be removed continuously and promptly from the reaction space. The amount of process gas can be controlled in the reduction reactor for the production of silicon by means of the amount of silicon carbide as activator or as source of carbon. Increasing the amount of silicon carbide reduces the amount of carbon monoxide in the reduction step in silicon production. Moreover, the removal of the process gases can be optimized, this is possible by adding porous briquettes and/or a smaller design of the reactors.

According to the invention, the reactors, in particular reactors 1 and/or 2, have the sandwich construction described above, in order to stop thermally-induced diffusion of impurities, in particular of boron, into the reaction space. Accordingly, it is further preferred that all parts of the device or installation that are operated at high temperatures or are heated indirectly to high temperatures have this sandwich construction. For example, in the production of silicon by reduction in the arc furnace, temperatures above 1800° C. are reached.

Preferably all parts of the device, in particular all parts of the device that come in contact with the reactants and/or reaction products, preferably the reactor 1, the reactor 2, the electrodes, ancillary components of the device, connectors and/or pipework, in particular that are operated at high temperatures or are heated indirectly, also by contact with hot gases, are lined with high-purity refractory material, in particular with high-purity silicon carbide or high-purity graphite.

According to the invention, all parts of the device that come in contact with the reactants and/or reaction products, in particular with silicon oxide, a source of carbon, process gases or reaction products, such as reactor 1 for melting and optionally for reduction of silicon oxide comprising a metal tap-hole and optionally a slag hole, in particular electrodes, and optionally at least one reactor 2 upstream of reactor 1, said reactor 2 serving for calcining and/or reduction of silicon oxide with at least one or more sources of carbon, are lined with high-purity refractory material, in particular with high-purity silicon carbide or high-purity graphite. Preferably lining with silicon-infiltrated silicon carbide and/or with graphite-containing and/or silicon carbide-containing carbon fibres is also possible. Alternatively it may be preferable for the silicon carbide to be of high purity and substantially free from carbon that is not bound in the silicon carbide.

A sandwich construction with at least two layers is also preferable for all parts of the device that are operated at high temperatures, or are heated indirectly, for example by hot process gases, with the sandwich construction for example for a feed line, discharge line or a connector being lined internally with a first layer (7) of high-purity refractory material, in particular with high-purity silicon carbide or high-purity graphite, and having another outer layer (6), which acts as insulating and/or diffusion barrier against impurities, and optionally outside of the aforementioned layer has a mechanically stable outermost layer (8).

According to the invention the high-purity refractory material is silicon carbide, silicon-infiltrated silicon carbide, graphite, each optionally reinforced with graphite fibres and/or carbon fibres. The total content of impurities, such as boron, phosphorus, aluminium, iron is in particular below 100 wt.-ppm, preferably below 10 wt.-ppm. High-purity refractory material according to the invention has the impurity profile defined at the beginning or the purity defined above for pure to high-purity silicon carbide or high-purity graphite. The impurities can be determined by ICP-MS, spectral analysis or resistance measurement.

If reactor 1 is operated without reactor 2, a separate gas outlet is required for removing the process gases.

Reactor 2 can be designed as a reduction shaft, it can for example be electrically heated, in particular by electrodes, which according to the invention contain silicon-infiltrated silicon carbide or silicon carbide, projecting through the shaft walls, according to an alternative the reduction shaft can be heated by a microwave furnace, for example in this embodiment it can be designed as a kind of fluidized bed, and in this alternative the process gases leaving at the bottom of reactor 1 can be led through the fluidized bed and thus contribute to heating of the silicon oxide and of the sources of carbon.

### Preferred Complete Method for the Production of Silicon

According to a general embodiment of the present invention, the method of reduction of purified silicon dioxide can be carried out as follows in a general process line.

Starting from for example purchased silicate solutions water glass, if the silicate solutions are not already of sufficient purity, purification of the silicate solution can be carried out. This can for example take place, in a first step, by diluting the silicate solution with deionized water or distilled water, separating solid constituents by usual filtration techniques, which are known by a person skilled in the art.

The diluted and filtered silicate solution can, in a special variant of the present method for separation of phosphorus, be led over an ion-exchange column with molybdenum salts. Alternatively a suitably diluted silicate solution can also be purified by a method of EP 0 5004 467 B1 to a stable aqueous silica sol. The silica sol thus obtained must be completely dissolved again before further acid precipitation and then undergoes precipitation according to the invention in an acidifying agent.

Since every additional process step means additional expense, the method according to the invention will preferably start from usual purchased silicate solutions and the additional steps described previously can preferably be carried out when a sufficiently clean silicate solution is not available or it is prepared by dissolving contaminated silicon dioxides.

Any solid constituents present can be removed from the silicate solutions by filtration.

Purified silicon oxide is produced from the silicate solution by precipitation as described above.

Preferably, however, crystalline sugar (source of pure carbon) is added to at least a portion of this silicon oxide, at least partially in the moist state, and optionally a thermal black and siloxanes are added as binders. The pasty mixture obtained is formed for example in an extruder and undergoes at least partial drying.

The briquettes obtained can then be pyrolyzed, to obtain a source of pure carbon with active carbon. The pyrolyzed carbon (active carbon) is added to the subsequent process for the production of silicon to improve the thermal and/or electrical conductivity.

Another portion of the briquettes can be pyrolyzed and calcined, to produce silicon carbide-containing briquettes. These silicon carbide-containing briquettes are added to the processes according to the invention later to reduce the proportion of carbon monoxide in the actual reduction step to pure silicon. Other functions of the silicon carbide are as an activator, a reaction accelerator and for improving conductivity.

For reduction of the purified silicon dioxide, preferably briquettes containing the purified silicon dioxide, thermal black and/or sugar and briquettes from the aforementioned pyrolysis and/or briquettes that have undergone pyrolysis and calcining are reduced to pure silicon in an arc furnace at about 1800° C. The gas loading of the process with carbon monoxide can be controlled directly by means of the addition of the content of silicon carbide. According to the invention, the reaction is preferably carried out in an arc furnace with a reactor of the stated sandwich construction, the inner lining of which is of high-purity silicon carbide. The electrodes used are preferably segmented silicon-infiltrated silicon carbide electrodes containing carbon fibre. Fused silicon can be discharged at the metal tap-hole, and can if required undergo directional solidification. The silicon obtained had the required purity for solar-grade silicon.

The device according to the invention and the reactor according to the invention are explained below, without limiting the invention to these embodiments.

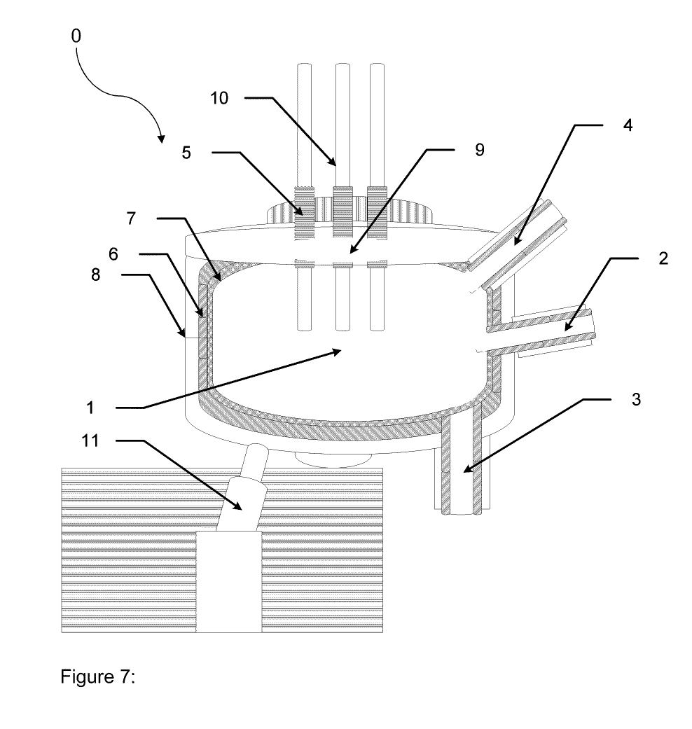

Thus, FIG. 7 shows a preferred embodiment of the reactor according to the invention.

### LIST OF REFERENCE SYMBOLS

0 reactor
1 reaction space
2 slag hole
3 metal tap-hole
4 waste gas/gas outlet
5 electrode bushing
6 diffusion barrier, in particular with superinsulation (outermost layer)
7 reactor space lining (first layer)
8 reactor body carrier (mechanically stable outermost layer)
9 reactor cover
10 electrode
11 tilting hydraulics

A reactor according to the invention 0, in particular as an arc furnace, has a reaction space 1, into which the electrodes 10 project through the electrode bushing 5 in the reactor cover 9. Preferably the reactor has several electrodes, in particular three electrodes 10. These electrodes 10 can be segmented, to permit continuous feed from outside of the reactor 0. To allow the process gases that form, such as carbon monoxide, to escape, the reactor has a gas outlet 4. Preferably underneath the reactor, a separate hydraulic tilting system 11 is provided, which permits reactor 0 to be tilted so that the slag that forms is discharged through the slag hole 2. The fused silicon produced is discharged continuously or discontinuously from the reaction space 1 via the metal tap-hole 3. The insulating and/or diffusion barrier (6) preferably comprises a glass body, which is silvered toward the reaction space. The glass body (6) is especially preferably made of high-purity quartz glass and/or is provided with an infrared-reflecting layer toward the interior of the reactor. Preferably the glass body has a vacuum inside, in particular a superinsulation, which is for example produced chemically. Toward the reactor interior, the diffusion barrier (6, outermost layer) is provided with high-purity silicon carbide or high-purity graphite, or also with suitably pure silicon carbide and/or pure graphite, as reactor space lining (7). The reactor space lining forms the first layer (7). To improve the economics of reactor operation and therefore increase the life of the reactor space lining, the latter is segmented. The individual segments of the first layer (7) can be joined together detachably, by a groove/spring principle. The reactor 0 can be filled continuously or discontinuously. For discontinuous filling, the reactor cover 9 can be opened. For continuous operation, the reactor can be provided with an additional feed line.

The following examples explain the method according to the invention in more detail, without limiting the invention to these examples.

### Methods of Measurement:

### Determination of the pH Value of the Precipitation Suspension

The method, based on DIN EN ISO 787-9, is used for determining the pH value of an aqueous suspension of silicon dioxide or the pH value of a substantially SiO₂-free wash liquid.

Before carrying out the pH measurement, the pH meter (from Knick, type: 766 pH-Meter Calimatic with temperature sensor) and the pH electrode (single-rod measuring cascade from Schott, type N7680) are to be calibrated using the buffer solutions at 20° C. The calibration function is to be selected such that the two buffer solutions used include the expected pH value of the sample (buffer solutions with pH 4.00 and 7.00, pH 7.00 and pH 9.00 and if necessary pH 7.00 and 12.00).

In steps a) and d) of the precipitation process for the production of purified silicon dioxide, determination of the pH value is carried out at 20° C. In step c of this method, the measurement is carried out at the respective temperature of the reaction solution. For measurement of the pH value, the electrode is first rinsed with deionized water, then with some of the suspension, and is then dipped in the suspension. When the pH-meter indicates a constant value, the pH value is read off from the display.

Determination of Average Particle Size d₅₀ of the High-Purity Silicon Dioxide for Particle Sizes Less than 70 μm with the Laser Diffraction Instrument Coulter LS 230

### Description

The application of laser diffraction according to the Fraunhofer model for determination of particle sizes is based on the phenomenon that particles scatter monochromatic light with different intensity pattern in all directions. This scatter depends on the particle size. The smaller the particles, the larger the scatter angles.

### Procedure:

After switching on, the laser diffraction instrument Coulter LS 230 requires a warming-up time of 1.5 to 2.0 hours, in order to obtain constant measured values. The sample must be shaken thoroughly before measurement. First the program “Coulter LS 230” is started with a double-click. Check that “Use Optical Bench” is activated and that the display on the Coulter instrument shows “Speed off”. Press the button “Drain” and keep it depressed until the water in the measuring cell has drained away, then press button “On” on the fluid transfer pump and again keep it depressed, until the water runs into the overflow of the instrument. Carry out this operation twice. Then press “Fill”. The program starts on its own and removes any air bubbles from the system. The speed is automatically raised and lowered again. Set the pump power selected for the measurement.

Before the measurement, it is necessary to establish whether measurement will be with or without PIDS. To start measurement, select “Measurement” “Measuring cycle”.

a) Measurement without PIDS

Measurement time is 60 seconds, waiting time 0 seconds. Then the calculation model forming the basis of laser diffraction is selected. Basically, a background measurement is carried out automatically before each measurement. After the background measurement, put the sample in the measuring cell, until a concentration of 8 to 12% is reached. This is reported by the program, with “OK” appearing at the top. Finally, click on “Ready”. The program now carries out all necessary steps itself and, following the measurement cycle, generates a particle size distribution of the test sample.

b) Measurement with PIDS

Measurements with PIDS are carried out when the expected particle size distribution is in the submicron range.

Measurement time is 90 seconds, waiting time 0. Then the calculation model forming the basis of laser diffraction is selected. Basically, a background measurement is carried out automatically before each measurement. After the background measurement, put the sample in the measuring cell, until a concentration of at least 45% is reached. This is reported by the program, with “OK” appearing at the top. Finally, click on “Ready”. The program now carries out all necessary steps itself and, following the measurement cycle, generates a particle size distribution of the test sample.

Determination of Average Article Size d₅₀ of the “Doughnut”-Shaped or “Toadstool Cap”-Shaped Products

100 representative particles are selected and the diameter of each particle [is measured] under a light microscope. As the particles can be of irregular shape, the diameter is determined at the point with the largest diameter. The mean value of all particle diameters determined corresponds to the d₅₀ value.

Determination of the Dynamic Viscosity of Silicate Solutions with the Falling Sphere Viscosimeter

The dynamic viscosity of water glass is determined with the falling sphere viscosimeter (Höppier Viscosimeter, from Thermo Haake).

### Procedure

The water glass (approx. 45 cm³) is poured bubble-free into the falling tube of the falling sphere viscosimeter (Thermo Haake, Falling Sphere Viscosimeter C) to below the end of the tube and then the sphere (Thermo Haake, set of spheres type 800-0182, Sphere 3, density δ_{K}=8.116 g/cm³, diameter d_{K}=15.599 mm, sphere-specific constant K=0.09010 mPa*s*cm³/g) is inserted. The viscosimeter temperature is adjusted accurately, by means of a circulating thermostat (Jalubo 4) to 20±0.03° C. Before the measurement, the sphere is passed once through the tube for thoroughly mixing the water glass. After a 15-minute pause, the first measurement begins.

The measuring element locks in the 10° position defined at the base of the instrument. By turning the measuring element through 180°, the sphere is brought to the starting position for the measurement. The time t for falling through the measurement section A-B is determined with a stopwatch. The start of the measurement time begins when the bottom edge of the sphere touches the upper annular sighting mark A, which must appear as a line to the observer. The measurement time ends when the bottom edge of the sphere reaches the lower annular mark B, which must also appear as a line. By turning the measuring element through 180° again, the sphere drops back to the starting position. After a 15-minute pause, a second measurement as described is carried out. Repeatability is verified if the measured values do not differ from one another by more than 0.5%.

The dynamic viscosity of the water glass (θ_{WGL}) in mPa*s is calculated from the numerical value equation

θ_{WGL}=K*(δ_{K}−δ_{WGL})*t
Sphere constant: K=0.09010 mPa*s*cm³/g
Sphere density: δ_{K}=8.116 g/cm³
Density of water glass: δ_{WGL} in g/cm³
t=travel time of the sphere, s
   to an accuracy of one decimal place.
   100 mPa*s corresponds to 1 poise.

### Determination of the Conductivity of the Washing Medium

For determination of the electrical conductivity of an aqueous suspension of silicon dioxide—or the electrical conductivity of a substantially SiO₂-free wash liquid—the aqueous suspension/wash liquid is carried out at room temperature on the basis of DIN EN ISO 787-14.

### Determination of Flow Velocity

The flow velocity is determined using the volume flowmeter P-670-M from the company PCE-Group with water flow probe. The probe is positioned in a region of the reactor that is defined width-wise by the reactor semi-radius ±5 cm and height-wise by the surface of the feed/precipitation suspension to 10 cm below the surface of the feed/precipitation suspension. Read the instructions for the instrument.

### Determination of Content of Impurities:

Description of the method for determination of trace elements in silica by high-resolution inductively coupled plasma-mass spectrometry (HR-ICPMS) (similar to test report A080007580)

Weigh 1-5 g of sample material to an accuracy of ±1 mg in a PFA beaker. Add 1 g mannitol solution (approx. 1%) and 25-30 g hydrofluoric acid (approx. 50%). After swirling briefly, heat the PFA beaker on a heating block to 110° C., so that the silicon contained in the sample as hexafluorosilicic acid and the excess hydrofluoric acid slowly evaporate. Dissolve the residue with 0.5 ml nitric acid (approx. 65%) and a few drops of hydrogen peroxide solution (approx. 30%) for about 1 hour and make up to 10 g with ultrapure water.

For determination of trace elements, take 0.05 ml or 0.1 ml from the decomposition solutions, transfer each to a polypropylene test tube, add 0.1 ml indium solution (c=0.1 mg/l) as internal standard and make up to 10 ml with dilute nitric acid (approx. 3%). Preparation of these two sample solutions at various dilutions serves for internal quality assurance, i.e. verification of whether errors were made during measurement or in sample preparation. It is in principle also possible to work with just one sample solution.

From multielement stock solutions (c=10 mg/l), containing all the elements to be analysed except indium, four calibration solutions are prepared (c=0.1; 0.5; 1.0; 5.0 μg/1), once again with addition of 0.1 ml indium solution (c=0.1 mg/l) to 10 ml final volume. In addition, blank-value solutions are prepared with 0.1 ml indium solution (c=0.1 mg/l) to 10 ml final volume.

The contents of elements in the blank-value, calibration and sample solutions are quantified by high-resolution inductively coupled mass spectrometry (HR-ICPMS) and by external calibration. Measurement is effected with a mass resolution (m/Δm) of min. 4000 or 10000 for the elements potassium, arsenic and selenium.

The following examples will explain the present invention in more detail but do not limit it in any way.

### COMPARATIVE EXAMPLE 1

Based on example 1 in WO 2007/106860 A1, 397.6 g water glass (27.2 wt. % SiO₂ and 8.0 wt. % Na₂O) were mixed with 2542.4 g deionized water. The diluted water glass was then passed through a column with inside diameter of 41 mm and length of 540 mm, filled with 700 ml (500 g dry weight) of Amperlite IRA 743 in water. After 13.5 min, a pH value of over 10 was measured at column outlet, so that by this point of time the first water glass had passed through the column. The sample of a total of 981 g purified water glass, taken between the 50th and 74th minute, was used for the subsequent tests.

The analytical data for the water glass before and after purification are presented in Table 1 below:

TABLE 1

| | | Water glass | |
|---|---|---|---|
| | Content | before ion | Water glass after |
| Contaminant | in | exchanger | ion exchanger |
| Aluminum | ppm | 31 | 31 |
| Boron | ppm | <1 | <1 |
| Calcium | ppm | 3 | 3 |
| Iron | ppm | 8 | 7 |
| Nickel | ppm | <0.3 | <0.3 |
| Phosphorus | ppm | <10 | <10 |
| Titanium | ppm | 8 | 2 |
| Zinc | ppm | <1 | <1 |
| Total for all | ppm | 66 | 57.5 |
| measured | | | |
| elements | | | |

The data in Table 1 show that the step described in WO 2007/106860 A1 as important in the purification of water glass on Amperlite IRA 743 with commercially available water glass does not show any marked purification effect and only brings about a slight improvement in the case of the titanium content.

The purified water glass was processed further, as in Example 5 in WO 2007/106860 A1, to SiO₂. For this, 700 g of the water glass was acidified with 10% sulphuric acid in a 2000 ml round-bottom flask, with stirring. The initial pH value was 11.26. After adding 110 g of sulphuric acid, the gel point was reached at pH 7.62, and 100 g of deionized water was added to restore the stirrability of the suspension. After adding a total of 113 g sulphuric acid, a pH value of 6.9 was reached, and it was stirred for 10 minutes at this pH value. Then it was filtered with a Büchner funnel with diameter of 150 mm. The product obtained had very poor filterability. After washing five times, with 500 ml deionized water each time, the conductivity was 140 μS/cm. The filter cake obtained was dried for 2.5 days at 105° C. in a circulating-air drying cabinet, obtaining 25.4 g of dry product. The analytical results are given in Table 2.

### EXAMPLE 1

### According to the Invention

1808 g water glass (27.2 wt. % SiO₂ and 7.97 wt. % Na₂O) and 20.1 g of 50% sodium hydroxide solution were put in a 4000-ml quartz-glass round-bottom flask with two-neck adapter, ball condenser, Liebig condenser (each made of borosilicate glass) and 500 ml graduated cylinder—for collecting the distillate. The sodium hydroxide solution was added to give an increased Na₂O content in the concentrated water glass. The solution was covered with nitrogen to prevent reaction with carbon dioxide from the air and was then heated to boiling using a heating mantle. After 256 ml water had been distilled off, the Liebig condenser was replaced with a stopper and boiling was continued under reflux for a further 100 min. Then the concentrated water glass was cooled under a nitrogen atmosphere to room temperature and left to stand overnight. 1569 g of concentrated water glass with a viscosity of 537 mPa*s (i.e. 5.37 poise) was obtained.

2513 g of 16.3% sulphuric acid and 16.1 g of 35% hydrogen peroxide were put at room temperature in a 4000-ml quartz-glass two-necked flask with precision glass stirrer and dropping funnel (each made of borosilicate glass). Within 3 min, 1000 ml of the previously prepared concentrated water glass (9.8 wt. % Na₂O, 30.9 wt. % SiO₂, density 1.429 g/ml) was added dropwise, so that the pH value remained below 1. The temperature of the reaction mixture rose to 50° C. and it turned a deep orange. The suspension was stirred for a further 20 min and then the solid obtained was left to settle.

It was processed by decanting off the supernatant solution and adding a mixture of 500 ml deionized water and 50 ml of 96% sulphuric acid to the residue. While stirring, the suspension was heated to boiling, the solid was left to settle and the supernatant was again decanted. This washing process was repeated until the supernatant only had an extremely slight yellow coloration. Then it was washed repeatedly with 500 ml deionized water each time, until a pH value of the wash suspension of 5.5 was reached. The conductivity of the wash suspension was now 3 μS/cm. The supernatant was decanted off and the product obtained was dried overnight at 105° C. in a circulating-air drying cabinet. The analytical data for the product obtained are shown in Table 2 below:

TABLE 2

| | | SiO₂ after | SiO₂ accortding to |
|---|---|---|---|
| | | Comparative | the invention after |
| Contaminant | Content in | Example 1 | Example 1 |
| Aluminum | ppm | 720 | 0.5 |
| Boron | ppm | 1 | <0.1 |
| Calcium | ppm | 42 | 0.1 |
| Iron | ppm | 170 | 0.2 |
| Nickel | ppm | <0.3 | 0.3 |
| Phosphorus | ppm | <10 | <0.1 |
| Titanium | ppm | 57 | 0.4 |
| Zinc | ppm | <3 | 0.1 |
| Sodium | ppm | 6800 | 0.5 |
| Potassium | ppm | 34 | 0.3 |
| Total for all | ppm | <7837.3 | <2.6 |
| measured | | | |
| elements | | | |

The results in Table 2 show that the silicon dioxide obtained in the comparative example does indeed—as disclosed in WO 2007/106860 A1—have a low boron and phosphorus content, but the other impurities are so high that the silicon dioxide is not suitable as starting material for the production of solar-grade silicon.

The silicon dioxide produced by the method according to the invention has a total impurity content—for all measured elements—of only 2.6 ppm. The levels of contamination with the critical elements for the production of solar-grade silicon are, as shown in Table 2, within an acceptable range. It can thus be seen that with the method according to the invention—against the teaching of the prior art—it is possible to produce, without chelating agent or the use of ion-exchange columns, from commercially available, concentrated water glass and commercially available sulphuric acid, a silicon dioxide which, on the basis of its impurity profile, is eminently suitable as a starting material for solar-grade silicon.

### Examples—Pyrolysis

### COMPARATIVE EXAMPLE 2

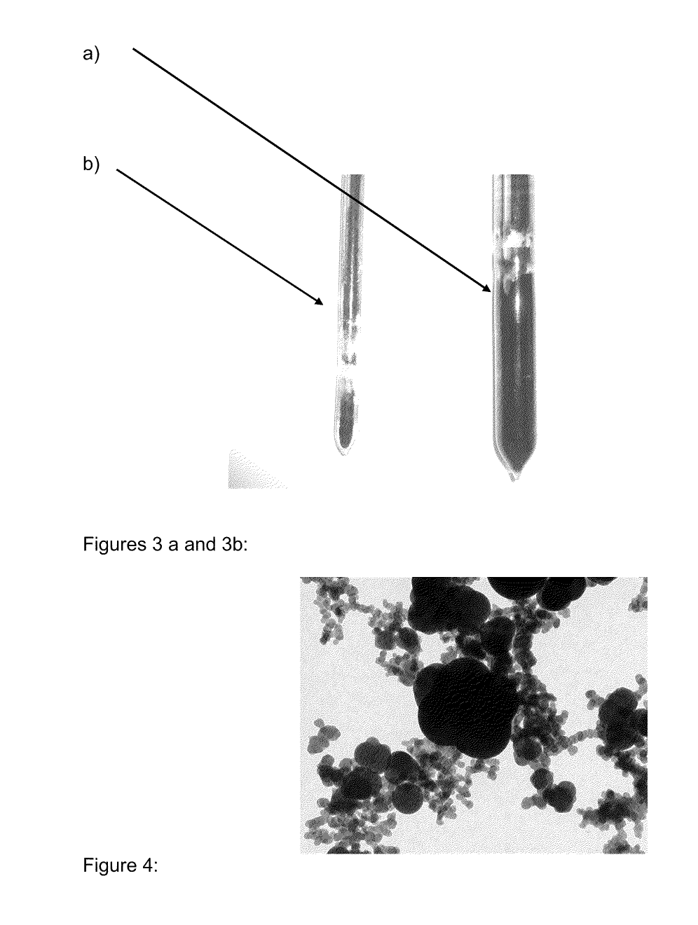

5 commercially available refined sugar was melted in a quartz glass under protective gas and then heated to about 1600° C. There was considerable foaming of the reaction mixture, partially escaping—caramel formation was also observed, and the pyrolysis product adhered to the wall of the reaction vessel (cf. FIG. 3a).

### EXAMPLE 2

Commercially available refined sugar was mixed with SiO₂ (Sipernat® 100) in the weight ratio 20:1, melted and heated to about 800° C. 15. No caramel formation was observed, and no foaming occurred. A graphite-containing, particulate pyrolysis product was obtained, which advantageously did not adhere substantially to the wall of the reaction vessel.

### Examples: Pyrolysis and Calcining

### COMPARATIVE EXAMPLE 3

Commercially available refined sugar was melted in a quartz glass and then heated to about 1600° C. There is considerable foaming of the reaction mixture during heating and some of it escapes from the quartz glass. At the same time, caramel formation is observed. The pyrolysis product formed adheres to the wall of the reaction vessel (FIG. 3a).

### EXAMPLE 3a

Commercially available refined sugar was mixed with SiO₂ (Sipernat® 100) at a weight ratio of 1.25 to 1, melted and then heated to about 800° C. Caramel formation is observed, but no foaming. A graphite-containing, particulate pyrolysis product is obtained, which in particular does not adhere to the wall of the reaction vessel (FIG. 3b). FIG. 4 is a micrograph of the pyrolysis product from Example 3a. The pyrolysis product is distributed on and presumably also in the pores of the SiO₂ particle. The particulate structure is retained.

### EXAMPLE 3b

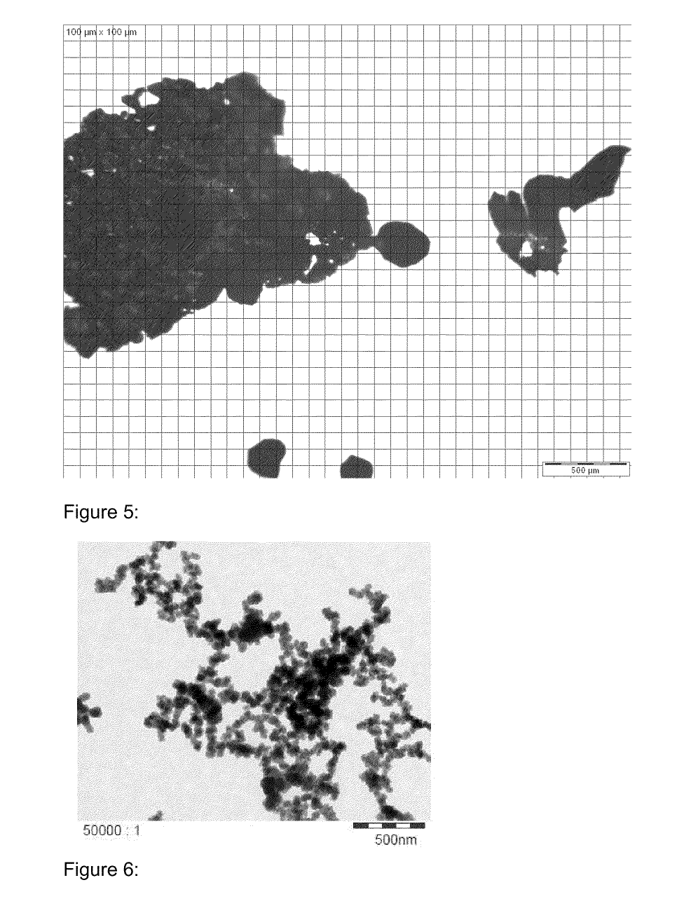

Commercially available refined sugar was mixed with SiO₂ (Sipernat® 100) at a weight ratio of 5 to 1, melted and then heated first to about 800° C. and then to about 1800° C. Caramel formation is observed, but there is no foaming. A silicon carbide with graphite components is obtained. FIGS. 5 and 6 are micrographs of two samples of the calcined product. Formation of silicon carbide was detected from XPS spectra and determination of the binding energies. Furthermore, Si—O structures were also detected. It was concluded from the metallic luster under a light microscope that there was formation of graphite.

### EXAMPLE 4

A fine-particulate formulation of sugar, coated on SiO₂ particles, is reacted at elevated temperature in a rotary kiln with SiO₂ spheres for heat distribution. For example produced by dissolving sugar in an aqueous silicic acid solution with subsequent drying and if necessary homogenization. There was still residual moisture in the system. About 1 kg of the formulation was used.

The residence time in the rotary kiln depends on the water content of the fine-particulate formulation. The rotary kiln was equipped with a preheating zone for drying the formulation, then the formulation traveled through a pyrolysis and calcining zone with temperatures from 400° C. to 1800° C. The residence time including the drying step, pyrolysis and calcining step was about 17 hours. Throughout the process, the process gases that formed, such as steam and CO, could be removed by simple means from the rotary kiln.

The SiO₂ used had a boron content of less than 0.1 ppm, phosphorus of less than 0.1 ppm and an iron content of less than about 0.2 ppm. The iron content of the sugar was determined prior to formulation at less than 0.5 ppm.

After pyrolysis and calcining, the contents were determined again, with the content of boron and phosphorus being determined at below 0.1 ppm, and the iron content had increased to 1 ppm. The increased iron content can only be explained by the product coming in contact with through contact with parts of the furnace that are contaminated with iron.

### EXAMPLE 5

Example 4 was repeated, with a laboratory rotating-tube furnace being coated beforehand with high-purity silicon carbide. This was reacted at elevated temperature with SiO₂ spheres for heat distribution and a fine-particulate formulation containing sugar, coated on SiO₂ particles. For example prepared by dissolving sugar in an aqueous silicic acid solution with subsequent drying and if necessary homogenization. There was still residual moisture in the system. About 10 g of the formulation was used. The residence time in the rotary kiln depends on the water content of the fine-particulate formulation. The rotary kiln was equipped with a preheating zone for drying the formulation, then the formulation traveled through a pyrolysis and calcining zone with temperatures from 400° C. to 1800° C. The residence time including the drying step, pyrolysis and calcining step was about 17 hours. Throughout the process, the process gases that formed, such as steam and CO, could be removed by simple means from the rotary kiln.

The SiO₂ used had a boron content of less than 0.1 ppm, phosphorus of less than 0.1 ppm and an iron content of less than about 0.2 ppm. The iron content of the sugar was determined prior to formulation at less than 0.5 ppm.

After pyrolysis and calcining, the contents were determined again and the content of boron and phosphorus was determined as less than 0.1 ppm, and moreover the iron content was less than 0.5 ppm.

### EXAMPLE 6

A fine-particulate formulation of pyrolyzed sugar on SiO₂-particles is reacted at elevated temperature in an arc furnace. The formulation of pyrolyzed sugar was prepared beforehand by pyrolysis in the rotary kiln at about 800° C. About 1 kg of the fine-particulate pyrolyzed formulation was used.

During the reaction in the arc furnace, the process gas CO that forms can easily escape through the interstices that are formed by the particulate structure of the SiO₂ particles, and is withdrawn from the reaction space. The electrodes used were high-purity graphite electrodes, and high-purity graphite was also used for lining the reactor bottom. The arc furnace was operated with 1 to 12 kW.

After the reaction, high-purity silicon carbide was obtained with graphite components, i.e. in a carbon matrix.

The SiO₂ used had a boron content of less than 0.17 ppm, phosphorus of less than 0.15 ppm and an iron content of less than about 0.2 ppm. The iron content of the sugar was determined prior to formulation at less than 0.7 ppm.

After pyrolysis and calcining, the contents in the silicon carbide were determined again and the content of boron and phosphorus was moreover less than 0.17 ppm or less than 0.15 ppm respectively, and moreover iron content was determined at less than 0.7 ppm.

### EXAMPLE 7

Corresponding reaction of a pyrolyzed formulation according to Example 3 was carried out in a microwave reactor. For this, about 0.1 kg of a dry, fine-particulate formulation of pyrolyzed sugar on SiO₂-particles was reacted at frequencies above 1 gigawatt to silicon carbide in a carbon matrix. The reaction time is directly dependent on the power input and the reactants.

If reaction takes place starting from carbohydrates and SiO₂ particles, the reaction times are correspondingly longer.

### EXAMPLE 8

SiO₂ (Aerosil® OX 50) and C (graphite) were reacted at a weight ratio of approx. 75:25 in the presence of SiC.

Procedure: an electric arc, which serves as the energy source, is struck in the known manner. The reaction starts insidiously with the evolution of gaseous compounds between SiO₂ and C. Then 1 wt. % of pulverulent SiC is added. After a very short time, a very marked increase in reaction can be observed from the occurrence of luminous phenomena. After that, the reaction continued after addition of SiC with an intense, bright orange-coloured glow (approx. 1000° C.). The solid obtained on completion of the reaction was identified as silicon on the basis of its typically dark-brown colour (M. J. Mulligan et al. Trans. Soc. Can. [3] 21 III [1927] 263/4; Gmelin 15, Part B p. 1[1959]) and by scanning electron microscopy (SEM).

### EXAMPLE 9

SiO₂ (Aerosil® OX 50) and C were reacted at a weight ratio of approx. 65:35 in the presence of SiC.

Procedure: an electric arc, which serves as the energy source, is struck in a known manner. Reaction between SiO₂ and C begins insidiously. Gases evolved to be recognized. 1 wt. % of pulverulent SiC is added, after a short time this leads to a marked increase in reaction, discernible from the occurrence of luminous effects. After adding SiC, reaction continued for some time, with an intense, flickering glow. The solid obtained on completion of the reaction was identified as silicon by SEM and EDX analysis (energy-dispersive X-ray spectroscopy).

### COMPARATIVE EXAMPLE 4

SiO₂ (Aerosil® OX 5O) and C were reacted in a tube as a 65:35 mixture at high temperature (>1700° C.). The reaction barely started, and there was no notable progress. No bright glow was observed.

1. A process for preparing pure silicon, comprising the reduction of purified silicon oxide with one or more pure carbon sources, wherein the silicon oxide has been purified as silicon oxide dissolved in the aqueous phase and, based on the silicon oxide, has a content of non-silicon oxide based polyvalent metals of less than or equal to 300 ppm.

2. A process according to claim 1, wherein the aqueous phase purification of the silicon oxide comprises at least one process step in which the aqueous silicon oxide solution is contacted with an ion exchanger.

3. A process according to claim 1, wherein the purified silicon oxide is obtained from the aqueous phase silicon oxide solution by gel formation or spray drying or by concentrating the silicon oxide solution to a concentration greater than or equal to 10% by weight of SiO₂ with subsequent contacting with an acidifying agent.

4. A process according to claim 3, wherein the gel formation is carried out with addition of ammonia, or a calcination of the gel is performed at temperatures up to 1500° C., or a combination thereof.

5. A process according to claim 1, wherein the purification of the silicon oxide essentially dissolved in the aqueous phase comprises the following steps:
a) providing silicates dissolved in the aqueous phase;
optionally adding soluble alkaline earth metal or transition metal salts, or a combination thereof, and optionally filtering the aqueous phase to remove sparingly soluble alkaline earth metal or transition metal salts or other insoluble constituents or a combination thereof,
optionally contacting the aqueous phase with an immobilized compound which complexes boron or boron compounds and
b) optionally adjusting the aqueous phase to a content of from 2 to 6% by weight of SiO₂, which additionally comprises other polyvalent metal oxide than silicon dioxide, and
c) contacting with a strongly acidic cation exchange resin of the hydrogen type, in an amount which is sufficient for the ion exchange of essentially all other metal ions in the aqueous phase, the temperature of the aqueous phase being in the range from 0° C. to 60° C.,
d) obtaining the aqueous phase of an active silica with an SiO₂ concentration of from 2 to 6% by weight and a pH of from 0 to 4,
e) obtaining purified silicon oxide.

6. A process according to claim 5, wherein the aqueous phase from step d), before step e), is alternatively treated further by the following steps a.2), b.2), c.2) or d.2):
a.2) adding to an acidifying agent or adding an acidifying agent, the aqueous phase from step d) optionally having been brought beforehand to a concentration of SiO₂ greater than or equal to 10% by weight, or
b.2) performing a gel formation, optionally followed by a thermal aftertreatment or spray-drying or a combination thereof, or
c.2) spray-drying the aqueous phase or
d.2) further treatment by, in a first step 1), adding a strong aqueous acid to the aqueous phase composed of active silica from step d), such that the pH is from 0 to 2.0, and keeping the aqueous phase thus obtained at from 0° C. to 100° C. for from 0.5 to 120 hours; by, in a second step 2), contacting the resulting aqueous phase with a strongly acidic cation exchange resin of the hydrogen type in an amount which is sufficient for the ion exchange of essentially all other metal ions in the aqueous phase, the temperature of the aqueous phase being in the range from 0 to 60° C., then, in the third step 3), contacting the aqueous phase with a strongly basic anion exchange resin of the hydroxyl type in an amount which is sufficient for the ion exchange of essentially all anions in the aqueous phase, the temperature of the aqueous phase being from 0 to 60° C., then, in the fourth step 4), obtaining the aqueous phase of the resulting active silica, which is essentially free of other dissolved substances than the active silica, and has a concentration of SiO₂ of from 2 to 6% by weight and a pH of from 2 to 5.

7. A process according to claim 6, wherein the aqueous phase obtained in the fourth step 4) in d.2) is alternatively treated further by one of the following steps a.3), b.3), c.3) or d.3)
a.3) concentrating the aqueous phase from the fourth step 4) of d.2) to a concentration of SiO₂ greater than or equal to 10% by weight and adding to an acidifying agent or adding an acidifying agent or
b.3) performing a gel formation, optionally followed by a thermal aftertreatment or spray-drying, or a combination thereof, or
c.3) spray-drying the aqueous phase or
d.3) further treatment in a fifth step 5), by adding an aqueous sodium hydroxide or potassium hydroxide phase or a combination thereof, to the aqueous phase of the active silica, where the molar ratio of SiO₂/M₂O is from 60 to 200, and M is independently sodium or potassium and originates from the hydroxide added, and the SiO₂ originates from the aqueous phase of the active silica, and the temperature of the resulting aqueous phase is also kept at from 0 to 60° C. and a stabilized aqueous phase of an active silica with an SiO₂ concentration of from 2 to 6% by weight and a pH of from 7 to 9 is maintained, in a sixth step 6) the stabilized aqueous phase of the active silica is partly or fully added to a vessel as a stock solution and the stock solution is kept at from 70 to 100° C., the vessel can be kept under standard pressure or under reduced pressure, wherein the water removed is metered in by supplying further stabilized aqueous phase of the active silica from the preceding component step d.3) step 5) essentially to the degree in which water is removed, to form a stable aqueous silica sol with an SiO₂ concentration of from 30 to 50% by weight and a particle size of the colloidal silicon dioxide of from 10 to 30 nm; in a seventh step 7), the stable aqueous silica sol is contacted with a strongly acidic cation exchange resin of the hydrogen type at from 0 to 60° C. in such an amount that essentially all metal ions present in the sol are exchanged, the resulting aqueous phase is subsequently contacted with a strongly basic anion exchanger of the hydroxyl type at from 0 to 60° C. in such an amount that an aqueous acidic silica sol which is essentially free of polyvalent metals other than silicon oxide is obtained in the eighth step 8) and performing a gel formation.

8. A process according to claim 6, wherein the gel formation in step b.2) is effected with addition of an amine or ammonia or a combination thereof.

9. A process according to claim 8, wherein the gel formation is effected at a temperature in the range from 0 to 100° C. and the pH is kept at from 0 to 7 to form a stable aqueous sol.

10. A process according to claim 1, wherein silicon carbide is added as an activator or carbon source, or a combination thereof, in one process step to provide at least one formulations selected from:
a) a formulation comprising the purified silicon oxide and at least one pure carbon source and optionally silicon carbide and optionally silicon
b) a formulation comprising the purified silicon oxide and optionally silicon carbide and optionally silicon
c) a formulation comprising at least one pure carbon source and optionally silicon carbide and optionally silicon,
and wherein the particular formulation optionally contains binder.

11. A process according to claim 1, wherein the pure carbon source comprises an organic compound of natural origin, a carbohydrate, graphite, coke, coal, carbon black, thermal black, or pyrolyzed carbohydrate.

12. A process according to claim 1, wherein the process comprises a step in which a carbohydrate is pyrolyzed in the presence of silicon oxide as a defoamer, thereby producing at least one source of pure carbon.

13. A process according to claim 12, wherein the carbohydrate is purified before the pyrolysis by contacting with at least one ion exchanger.

14. A process according to claim 12, wherein the carbohydrate and the silicon oxide are subjected to a shaping process before the pyrolysis.

15. A process according to claim 1, wherein the purified silicon oxide is reduced with one or more pure carbon sources in a light arc furnace, in a thermal reactor, in an induction furnace, in a rotary tube furnace or in a microwave furnace, or any combination thereof.

16. A process according to claim 1, wherein the purified silicon oxide is reduced with one or more pure carbon sources in a reaction chamber lined with high-purity refractory materials and any electrodes used consist of high-purity material.

17. A process according to claim 1, wherein molten pure silicon is obtained and is purified further by zone melting or controlled solidification.

18. A process according to claim 1, comprising the steps of:
a) converting a silicon oxide containing impurities to silicon oxide dissolved in the aqueous phase,
b) purifying the silicate dissolved in the aqueous phase by contacting with a strongly acidic cation exchange resin,
c) obtaining a precipitate of purified silicon oxide and
d) converting the purified silicon oxide thus obtained to silicon in the presence of one or more carbon sources and optionally by addition of an activator.

19. A process according to claim 7, wherein the gel formation in step b.3) or after step d.3) step 8) is effected with addition of an amine or ammonia or a combination thereof.

20. A process according to claim 19, wherein the gel formation is effected at a temperature in the range from 0 to 100° C. and the pH is kept at from 0 to 7 to form a stable aqueous sol.
